(19) United States
(12) Patent Application Publication
(10) Pub. No.: US 2025/0039291 A1
(43) Pub. Date: Jan. 30, 2025

(54) DATA TRANSMISSION METHOD AND RELATED DEVICE

(71) Applicant: Huawei Technologies Co., Ltd., Shenzhen (CN)

(72) Inventors: Renqing Ma, Shanghai (CN); Chao Zhu, Shanghai (CN)

(21) Appl. No.: 18/838,015

(22) PCT Filed: Mar. 9, 2023
(86) PCT No.: PCT/CN2023/080503

§ 371 Date: Aug. 13, 2024

(30) Foreign Application Priority Data
Mar. 11, 2022 (CN) 202210250334.9

(51) Int. Cl. H04M 1/2757; H04L 67/1095; H04W 76/14

(52) U.S. Cl. CPC H04M 1/2757; H04L 67/1095; H04W 76/14

(57) ABSTRACT

This application discloses a data transmission method and a related device. On a basis of information synchronization between a mobile phone and a head unit by using Bluetooth in an existing PBAP, additional information (for example, a profile picture of a contact in an address book, SIM card information in a call record, a home location of an operator, yellow page information, and a call status) is synchronized by using another data exchange technology (for example, a distributed data service).

### CROSS-REFERENCE TO RELATED APPLICATIONS

This application is a National Stage of International Application No. PCT/CN2023/080503 filed on Mar. 9, 2023, which claims priority to Chinese Patent Application No. 202210250334.9, filed on Mar. 11, 2022. Both of the aforementioned applications are hereby incorporated by reference in their entireties.

### TECHNICAL FIELD

This application relates to the field of communication technologies, and in particular, to a data transmission method and a related device.

### BACKGROUND

With flourishing development of intelligent vehicles, increasingly more vehicle manufacturers install smart in-vehicle infotainment systems on vehicles of the vehicle manufacturers. A head unit usually has a Bluetooth phone application, and the application has functions of making a call, and viewing an address book and a call record. To implement the functions, an address book and a call record on a mobile phone of the user need to be synchronized to the head unit.

Currently, a commonly used head unit synchronization profile is a standard Bluetooth phone book access profile (phone book access profile, PBAP). However, the profile has a plurality of limitations (for example, only a field specified in the profile can be synchronized, only Bluetooth can be used as a transmission medium, and synchronization efficiency is low), and user experience is poor.

### SUMMARY

Embodiments of this application provide a data transmission method and a related device, to more comprehensively synchronize information such as an address book and a call record on a mobile phone to a head unit. This improves user experience.

According to a first aspect, an embodiment of this application provides a data transmission method, applied to a first electronic device. The method includes: The first electronic device establishes a communication connection to a second electronic device; receives, based on the communication connection, a first portion, of first data, that is sent by the second electronic device in a first manner; receives, based on the communication connection, a second portion, of the first data, that is sent by the second electronic device in a second manner; and displays a first object based on the first portion of the first data and the second portion of the first data. The first manner is different from the second manner, the first portion of the first data is used to generate first content of the first object, and the second portion of the first data is used to generate second content of the first object.

According to the method in the first aspect provided in this embodiment of this application, on a basis of information synchronization between a mobile phone and a head unit by using Bluetooth in an existing PBAP profile, additional information (for example, a profile picture of a contact in an address book, SIM card information in a call record, a home location of an operator, yellow page information, and a call status) is synchronized by using another technology (for example, a distributed data service technology), so that richer information of the mobile phone can be synchronized to the head unit when a synchronization speed and normal usage are ensured. This improves user experience.

In a possible implementation, the first data is phone book data, and the phone book data includes address book data and/or call record data.

In this way, the first electronic device may synchronize the address book data and the call record data on the second electronic device.

In a possible implementation, that the first electronic device receives, based on the communication connection, a first portion, of first data, that is sent by the second electronic device in a first manner specifically includes: The first electronic device receives, based on the communication connection, the first portion, of the first data, that is sent by the second electronic device according to a phone book access profile PBAP.

In this way, the first electronic device may receive, based on a Bluetooth communication connection, the first portion, for example, contact data 1 or call record data 1 shown in FIG. 5, of the first data, that is sent by the second electronic device according to the PBAP.

In a possible implementation, that the first electronic device receives, based on the communication connection, a second portion, of the first data, that is sent by the second electronic device in a second manner specifically includes: The first electronic device receives, based on the communication connection, the second portion, of the first data, that is sent by the second electronic device by using a service related to data synchronization, where the first electronic device is associated with the second electronic device by logging in to a first account (for example, a Huawei account); or the first electronic device receives, based on the communication connection, the second portion, of the first data, that is sent by the second electronic device by using a socket.

In this way, the first electronic device may receive, based on a Wi-Fi connection or another connection, the second portion, for example, contact data 2 or call record data 2 shown in FIG. 5, of the first data, that is sent by the second electronic device by using the service related to data synchronization.

In a possible implementation, the service related to data synchronization includes a distributed data service.

In a possible implementation, the first portion of the first data includes first phone number data, the second portion of the first data includes one or more of the following: identifier data of a SIM card, home data of an operator, yellow page data, and identifier data of a call status, the first object includes a first call record, the first call record is a call record corresponding to a first phone number, the first content includes the first phone number, and the second content includes one or more of the following: an identifier of a SIM card that generates the first call record, a home location of an operator of the first phone number, a yellow page name of the first phone number, and an identifier of a call status of the first phone number.

The first phone number may be a phone number in a call record that is on the second electronic device and that is displayed by the first electronic device.

In this way, the first electronic device may display the call record data (for example, the call record data 1) synchronized according to the PBAP, and may also display the call record data (for example, the call record data 2) synchronized by using the service related to data synchronization or the socket, to enrich synchronized information.

In a possible implementation, the first call record is a call record of a rejected incoming call, and the second content includes an identifier indicating that the call status of the first phone number is a rejected state.

In this way, a rejected incoming call that is forcibly converted by the PBAP into a missed call may be normally displayed as a rejected incoming call.

In a possible implementation, the second portion of the first data further includes first mark data, and when the first phone number is a phone number of a telemarketing type, the first mark data includes a telemarketing mark, and the second content includes the telemarketing mark.

In this way, the first electronic device may also display a call record of an unknown number with a telemarketing-type mark.

In a possible implementation, the first portion of the first data includes name data of a first contact and phone number data of the first contact, the second portion of the first data includes profile picture data of the first contact, the first object includes a first address book entry, the first address book entry is an address book entry corresponding to the first contact, the first content includes a name of the first contact, and the second content includes a profile picture of the first contact.

The first address book entry may be one address book entry (for example, “A Ye” shown in FIG. 8B) in an address book, displayed by the first electronic device, on the second electronic device, and the first contact may be one contact in the address book, displayed by the first electronic device, on the second electronic device.

In this way, the first electronic device may display the address book data (for example, the contact data 1) synchronized according to the PBAP, and may also display the address book data (for example, the contact data 2) synchronized by using the service related to data synchronization or the socket, to enrich synchronized information.

In a possible implementation, before the first electronic device displays the first object based on the first portion of the first data and the second portion of the first data, the method further includes: The first electronic device determines, based on a first identifier and a second identifier, that the first portion of the first data is associated with the second portion of the first data. The first identifier is an identifier of the first portion of the first data, and the second identifier is an identifier of the second portion of the first data.

When the first data is the address book data, the first identifier may be a unique identifier (for example, rawContactId or a hash value) of a contact corresponding to the address book data, and is sent according to the PBAP. Alternatively, the second identifier may be a unique identifier (for example, rawContactId or a hash value) of a contact corresponding to the address book data, and is sent by using the service related to data synchronization or the socket. When the first data is the call record data, the first identifier may be a phone number corresponding to the call record data, and is sent according to the PBAP. Alternatively, the second identifier may be a phone number corresponding to the call record data, and is sent by using the service related to data synchronization or the socket.

In this way, if the first identifier is the same as the second identifier, it indicates that the first portion of the first data is associated with the second portion of the first data. Further, the first electronic device may simultaneously display the first content of the first object and the second content of the first object based on the first portion of the first data and the second portion of the first data.

In a possible implementation, after the first electronic device displays the first object based on the first portion of the first data and the second portion of the first data, the method further includes: The first electronic device receives, under a first condition, second data sent by the second electronic device, and displays the first object based on the second data. The first condition includes: the second electronic device detects that the first data changes to the second data; or the first electronic device detects a refresh operation of a user, and sends a first request to the second electronic device, where the first request indicates the second electronic device to send the first data to the second electronic device.

The first request may be a synchronization request sent by the first electronic device to the second electronic device in a solution 2 of Embodiment 3, and the second data may be new data, on the second electronic device, that is generated after the first data is generated.

In this way, the first electronic device may refresh and display the first data on the second electronic device in real time, or refresh and display the first data on the second electronic device through manually triggering by the user.

In a possible implementation, after the first electronic device displays the first object based on the first portion of the first data and the second portion of the first data, the method further includes: When the communication connection is disconnected, the first electronic device clears the first portion of the first data and the second portion of the first data.

In this way, after the first electronic device is disconnected from the second electronic device, the first electronic device may clear the synchronized first data, to reduce unnecessary data that occupies large storage space.

In a possible implementation, before the first electronic device receives, based on the communication connection, the first portion, of the first data, that is sent by the second electronic device in the first manner, the method further includes: The first electronic device detects an operation of viewing the first object by the user.

In this way, the first electronic device may trigger, based on the user operation, synchronization of the first data on the second electronic device.

According to a second aspect, an embodiment of this application provides a data transmission method, applied to a first electronic device. The method includes: The first electronic device establishes a communication connection to a second electronic device; when a first SIM card and a second SIM card are installed on the second electronic device, receives, based on the communication connection, information about the first SIM card and information about the second SIM card that are sent by the second electronic device; and displays a first option and a second option based on the information about the first SIM card and the information about the second SIM card. The first option is used by a user to initiate a call business by using the first SIM card, and the second option is used by the user to initiate a call business by using the second SIM card.

In this way, the first electronic device may display information about a SIM card on the second electronic device, so that the user can select a corresponding SIM card on the first electronic device to perform a call business. This is simple and convenient, and improves user experience.

In a possible implementation, that the first electronic device receives, based on the communication connection, information about the first SIM card and information about the second SIM card that are sent by the second electronic device specifically includes: The first electronic device receives, based on the communication connection, the information about the first SIM card and the information about the second SIM card that are sent by the second electronic device by using a service related to data synchronization, where the first electronic device is associated with the second electronic device by logging in to a first account; or the first electronic device receives, based on the communication connection, the information about the first SIM card and the information about the second SIM card that are sent by the second electronic device by using a socket.

In a possible implementation, the service related to data synchronization includes a distributed data service.

In a possible implementation, after the first electronic device displays the first option and the second option based on the information about the first SIM card and the information about the second SIM card, the method further includes: The first electronic device detects an operation of the user for the first option, and sends a first request to the second electronic device, where the first request indicates the second electronic device to initiate a call business by using the first SIM card; when the second electronic device initiates the call business based on the first request, receives a first message sent by the second electronic device, where the first message indicates the first electronic device to display a call screen; and displays the call screen based on the first message.

The first request may be a call request shown in FIG. 9.

In a possible implementation, the information about the first SIM card includes one or more of the following: an identifier of the first SIM card, a phone number of the first SIM card, and a home location of an operator of the first SIM card; and the information about the second SIM card includes one or more of the following: an identifier of the second SIM card, a phone number of the second SIM card, and a home location of an operator of the second SIM card.

According to a third aspect, an embodiment of this application provides a data transmission method, applied to a second electronic device. The method includes: The second electronic device establishes a communication connection to a first electronic device; sends a first portion of first data to the first electronic device in a first manner based on the communication connection; and sends a second portion of the first data to the first electronic device in a second manner based on the communication connection. The first manner is different from the second manner, the first portion of the first data and the second portion of the first data are used by the second electronic device to display a first object, the first portion of the first data is used by the first electronic device to generate first content of the first object, and the second portion of the first data is used by the first electronic device to generate second content of the first object.

In a possible implementation, the first data is phone book data, and the phone book data includes address book data and/or call record data.

In a possible implementation, that the second electronic device sends a first portion of first data to the first electronic device in a first manner based on the communication connection specifically includes: The second electronic device sends the first portion of the first data to the first electronic device based on the communication connection and a phone book access profile PBAP.

In a possible implementation, that the second electronic device sends a second portion of the first data to the first electronic device in a second manner based on the communication connection specifically includes: The second electronic device sends the second portion of the first data to the first electronic device based on the communication connection and by using a service related to data synchronization, where the first electronic device is associated with the second electronic device by logging in to a first account; or the second electronic device sends the second portion of the first data to the first electronic device based on the communication connection and by using a socket.

In a possible implementation, the service related to data synchronization includes a distributed data service.

In a possible implementation, the first portion of the first data includes first phone number data, the second portion of the first data includes one or more of the following: identifier data of a SIM card, home data of an operator, yellow page data, and identifier data of a call status, the first object includes a first call record, the first call record is a call record corresponding to a first phone number, the first content includes the first phone number, and the second content includes one or more of the following: an identifier of a SIM card that generates the first call record, a home location of an operator of the first phone number, a yellow page name of the first phone number, and an identifier of a call status of the first phone number.

In a possible implementation, the first portion of the first data includes name data of a first contact and phone number data of the first contact, the second portion of the first data includes profile picture data of the first contact, the first object includes a first address book entry, the first address book entry is an address book entry corresponding to the first contact, the first content includes a name of the first contact, and the second content includes a profile picture of the first contact.

According to a fourth aspect, an embodiment of this application provides a data transmission method, applied to a second electronic device. The method includes: The second electronic device establishes a communication connection to a first electronic device; and when a first SIM card and a second SIM card are installed on the second electronic device, sends information about the first SIM card and information about the second SIM card to the first electronic device based on the communication connection. The information about the first SIM card is used by the first electronic device to display a first option, the first option is used by a user to initiate a call business by using the first SIM card, the information about the second SIM card is used by the first electronic device to display a second option, and the second option is used by the user to initiate a call business by using the second SIM card.

In a possible implementation, that the second electronic device sends information about the first SIM card and information about the second SIM card to the first electronic device based on the communication connection specifically includes: The second electronic device sends the information about the first SIM card and the information about the second SIM card to the first electronic device based on the communication connection and by using a service related to data synchronization, where the first electronic device is associated with the second electronic device by logging in to a first account; or the second electronic device sends the information about the first SIM card and the information about the second SIM card to the first electronic device based on the communication connection and by using a socket.

In a possible implementation, after the second electronic device sends the information about the first SIM card and the information about the second SIM card to the first electronic device based on the communication connection, the method further includes: The second electronic device receives a first request sent by the first electronic device, where the first request indicates the second electronic device to initiate a call business by using the first SIM card; initiates the call business based on the first request; and sends a first message to the first electronic device, where the first message indicates the first electronic device to display a call screen.

According to a fifth aspect, an embodiment of this application provides an electronic device. The electronic device includes one or more processors and one or more memories, the one or more memories are coupled to the one or more processors, the one or more memories are configured to store computer program code, the computer program code includes computer instructions, and when the one or more processors execute the computer instructions, the electronic device is enabled to perform the method in any one of the possible implementations of the first aspect, the second aspect, the third aspect, or the fourth aspect.

According to a sixth aspect, an embodiment of this application provides a computer storage medium. The computer storage medium stores a computer program, the computer program includes program instructions, and when the program instructions are run on an electronic device, the electronic device is enabled to perform the method in any one of the possible implementations of the first aspect, the second aspect, the third aspect, or the fourth aspect.

According to a seventh aspect, an embodiment of this application provides a communication system. The communication system includes a first electronic device and a second electronic device, the first electronic device is configured to perform the method in the first aspect or the second aspect, and the second electronic device is configured to perform the method in the third aspect or the fourth aspect.

According to an eighth aspect, an embodiment of this application provides a computer program product. When the computer program is run on a computer, the computer is enabled to perform the method in any one of the possible implementations of the first aspect, the second aspect, the third aspect, or the fourth aspect.

### BRIEF DESCRIPTION OF THE DRAWINGS

FIG. 1 is a diagram of an architecture of a communication system according to an embodiment of this application;

FIG. 2 is a diagram of a Bluetooth protocol structure of PCE and PSE according to an embodiment of this application;

FIG. 3 is a diagram of a storage form of source data according to an embodiment of this application;

FIG. 4 is a diagram of another Bluetooth protocol structure of PCE and PSE according to an embodiment of this application;

FIG. 5 is a schematic flowchart of a data transmission method according to an embodiment of this application;

FIG. 6 is a diagram of interaction in a data synchronization process by using a socket according to an embodiment of this application;

FIG. 7A and FIG. 7B are diagrams of a group of user interfaces that display contact data and call record data according to an embodiment of this application;

FIG. 8A and FIG. 8B are diagrams of another group of interfaces that display contact data and call record data according to an embodiment of this application;

FIG. 9 is a schematic flowchart in which a user selects a SIM card to perform a call business according to an embodiment of this application;

FIG. 10A and FIG. 10B are diagrams of a group of user interfaces on which a SIM card is selected and a call business is performed according to an embodiment of this application;

FIG. 11 is a diagram of a user interface that displays a refresh option according to an embodiment of this application;

FIG. 12 is a diagram of internal modules of an electronic device 100 and an electronic device 200 in a data synchronization process and a possible collaboration manner between the internal modules according to an embodiment of this application;

FIG. 13 is a diagram of internal modules of an electronic device 100 and an electronic device 200 in a data synchronization process by using a distributed data service and a possible collaboration manner between the internal modules according to an embodiment of this application;

FIG. 14 is a schematic flowchart of another data transmission method according to an embodiment of this application; and

FIG. 15 is a diagram of a structure of an electronic device according to an embodiment of this application.

### DETAILED DESCRIPTION OF ILLUSTRATIVE EMBODIMENTS

The following clearly describes technical solutions in embodiments of this application with reference to accompanying drawings in embodiments of this application. In the descriptions of embodiments of this application, unless otherwise stated, “/” represents “or”. For example, A/B may represent A or B. In this specification, “and/or” merely describes an association relationship between associated objects and represents that three relationships may exist. For example, A and/or B may represent the following three cases: Only A exists, both A and B exist, and only B exists. In addition, in the descriptions of embodiments of this application, “a plurality of” means two or more than two.

It should be understood that terms “first”, “second”, and the like in the specification, claims, and accompanying drawings of this application are intended to distinguish between different objects but do not describe a particular order. In addition, terms “include”, “have”, and any other variant thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned in this application means that a particular feature, structure, or feature described with reference to an embodiment may be included in at least one embodiment of this application. The phrase shown in various locations in the specification may not necessarily refer to a same embodiment, and is not an independent or optional embodiment exclusive from another embodiment. It is explicitly and implicitly understood by a person skilled in the art that embodiments described in this application may be combined with another embodiment.

A term “user interface (user interface, UI)” in the following embodiments of this application is a medium interface for interaction and information exchange between an application program or an operating system and a user, and implements conversion between an internal form of information and a form that can be accepted by the user. The user interface is source code written in a specific computer language like Java or an extensible markup language (extensible markup language, XML). Interface source code is parsed and rendered on an electronic device, and is finally presented as content that can be identified by the user. A frequently-used representation form of the user interface is a graphical user interface (graphical user interface, GUI), and is a user interface that is displayed in a graphical manner and that is related to a computer operation. The user interface may be a visual interface element like a text, an icon, a button, a menu, a tab, a text box, a dialog box, a status bar, a navigation bar, or a Widget that is displayed on a display of the electronic device.

With flourishing development of intelligent new energy vehicles, increasingly more vehicle manufacturers install smart in-vehicle infotainment system on vehicles of the vehicle manufacturers. A head unit usually has a Bluetooth phone application, and the application has functions of making a call, and viewing an address book (or referred to as a contact) and a call record. To implement the functions, an address book and a call record on a mobile phone of the user need to be synchronized to the head unit.

Currently, a commonly used head unit synchronization profile is a standard Bluetooth phone book access profile (phone book access profile, PBAP), to be compatible with mobile phones of different manufacturers. The PBAP profile specifies fields that can be synchronized in an address book and a call record, and Bluetooth needs to be used as a transmission medium. Consequently, the PBAP profile has a plurality of limitations. For example, limited by the PBAP profile, only a field (for example, fields such as a basic name and a phone number) specified in the profile can be synchronized, an additional field (for example, a profile picture of a contact in an address book, SIM card information in a call record, a home location of an operator, yellow page information, and a call status), and synchronized information is little. Only Bluetooth can be used as the transmission medium. Due to low bandwidth of Bluetooth (the bandwidth of Bluetooth is about 100 kb/s), synchronization efficiency is low, and information about an address book and a call record cannot be updated to the head unit in time. In the PBAP profile, a rejected call record is forcibly converted into an incoming call record, and a rejected status is missing in a call status of the head unit. Consequently, a display exception occurs in the call status, and a call record of the head unit is inconsistent with a call record of the mobile phone. In the PBAP profile, information about a subscriber identity module (subscriber identity module, SIM) cannot be synchronized. In a scenario in which two SIM cards are installed on the mobile phone, the head unit cannot support the user in selecting a SIM card to perform a call business. Because the existing PBAP profile has a plurality of limitations, user experience is poor, and the head unit implements few functions.

Therefore, how to synchronize information (for example, a profile picture of a contact in an address book, SIM card information in a call record, a home location of an operator, yellow page information, and a call status) on a mobile phone to a head unit more comprehensively and more quickly is an urgent problem to be resolved currently.

Embodiments of this application provide a data transmission method. On a basis of information synchronization between a mobile phone and a head unit by using Bluetooth in the existing PBAP profile, additional information (for example, a profile picture of a contact in an address book, SIM card information in a call record, a home location of an operator, yellow page information, and a call status) is synchronized by using another data exchange technology (for example, a distributed data service), so that richer information of the mobile phone can be synchronized to the head unit, and the head unit may also implement more functions based on the richer information. This improves user experience.

The following describes a communication system provided in embodiments of this application.

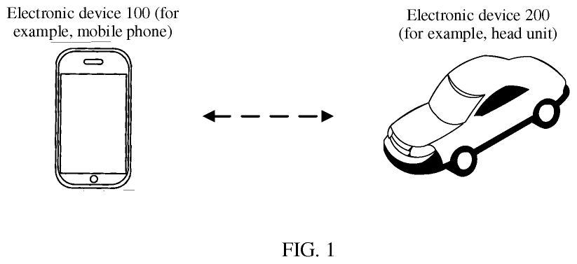

FIG. 1 shows an example of a communication system according to an embodiment of this application.

As shown in FIG. 1, the communication system may include an electronic device 100 and an electronic device 200.

The electronic device 100 may also be referred to as phone book server equipment (phone book server equipment, PSE), and may be an electronic device that has phone book source data and that serves as a server, for example, an electronic device that can implement a call function by using a SIM card, for example, a mobile phone or a watch.

The electronic device 200 may also be referred to as phone book client equipment (phone book client equipment, PCE), and may be a device that requests phone book information from the PSE and that serves as a client, for example, a head unit (namely, an in-vehicle infotainment device installed in a vehicle that can implement information communication between a person and a vehicle, and between a vehicle and another device).

The electronic device 100 and the electronic device 200 in the communication system may be connected by logging in to a same account. For example, the electronic device 100 and the electronic device 200 may log in to a same Huawei account, and remotely connect to and communicate with each other by using a server. The account may be a mobile phone number, an email address, a customized user name, a user name allocated by an APP server, a user name used for login in an APP in the electronic device, or the like.

The electronic device 100 and the electronic device 200 in the communication system may alternatively log in to different accounts, but are connected through binding. For example, after logging in to an account, the electronic device 100 may bind, in a device management application, the electronic device 200 that logs in to a different account or that does not log in an account, and then the electronic device 100 and the electronic device 200 may communicate with each other by using the device management application.

The electronic device 100 and the electronic device 200 in the communication system may alternatively establish a connection in a manner of scanning a two-dimensional code, near field communication (near field communication, NFC) OneHop, searching for a Bluetooth device, or the like. This is not limited herein.

Generally speaking, the communication connection established between the electronic device 100 and the electronic device 200 in the communication system may include but is not limited to: a wired connection, a wireless connection, for example, a Bluetooth (Bluetooth, BT) connection, a wireless local area network (wireless local area network, WLAN) connection, for example, a wireless fidelity point to point (wireless fidelity point to point, Wi-Fi P2P) connection, a near field communication (near field communication, NFC) connection, an infrared (infrared, IR) connection, a remote connection (for example, a connection established by using a server), or the like.

In addition, the electronic device 100 and the electronic device 200 in the communication system may be connected and communicate with each other in combination of any of the foregoing manners. This is not limited in embodiments of this application. In other words, the electronic device 100 and the electronic device 200 in the communication system may establish a network (namely, networking) according to a specific communication profile and a networking policy, so that the electronic device 100 and the electronic device 200 can communicate with each other.

The electronic device 100 and the electronic device 200 in the communication system may be configured with different software operating systems (operating system, OS), including but not limited to HarmonyOS®, Android®, iOS®, Windows®, Linux®, and the like. HarmonyOS® is Huawei HarmonyOS. The electronic device 100 and the electronic device 200 may alternatively be configured with a same software operating system, for example, may be configured with HarmonyOS®.

For ease of understanding, the PBAP profile used in a process of synchronizing information between the mobile phone and the head unit by using Bluetooth is first described.

The PBAP profile is an upper-layer profile according to an object exchange profile (object exchange profile, OBEX). The profile may be used to synchronize, to another electronic device (for example, a head unit), information such as an address book and a call record on an electronic device, for example, a mobile phone, that has a phone book function. An initial version of the profile is the Dogroo version released on May 20, 2004. With continuous development and optimization, the v1.2.0 version released on Nov. 5, 2013 is adopted by the Bluetooth Special Interest Group (Special Interest Group, SIG) Board of Directors for the first time, and the latest version is v1.2.3 released on Jan. 21, 2019. The PBAP profile specification subsequently used in embodiments of this application is according to the v1.2.1 version released on Dec. 15, 2015. For details, refer to related content in the <PBAP_v1.2.1.pdf> file.

The PBAP profile specifies two roles: PCE and PSE. The PBAP profile is used to synchronize source data of the PSE to the PCE.

The PBAP profile is an application layer profile according to the OBEX profile. Therefore, the following first describes the OBEX profile. The OBEX profile comes from the infrared communication profile, but is not limited to a specific transmission manner. Then, the Bluetooth SIG absorbs and optimizes a part of the OBEX profile as an OBEX layer in the Bluetooth protocol for file data transmission between Bluetooth devices. For example, in scenarios such as file transmission according to an object push profile (object push profile, OPP), phone book synchronization according to the PBAP profile, and short message synchronization according to a mobile application part (mobile application part, MAP) profile, the OBEX profile is used to organize related data transmission.

In the OBEX profile, there are also two roles: a client (client) and a server (server). The two roles interact with each other in a request-response (request-response) form, that is, the client sends a request, and the server transmits a data object in response to the request of the client. In the PBAP profile, the client can only read source data, but cannot modify the source data. This ensures security of the source data.

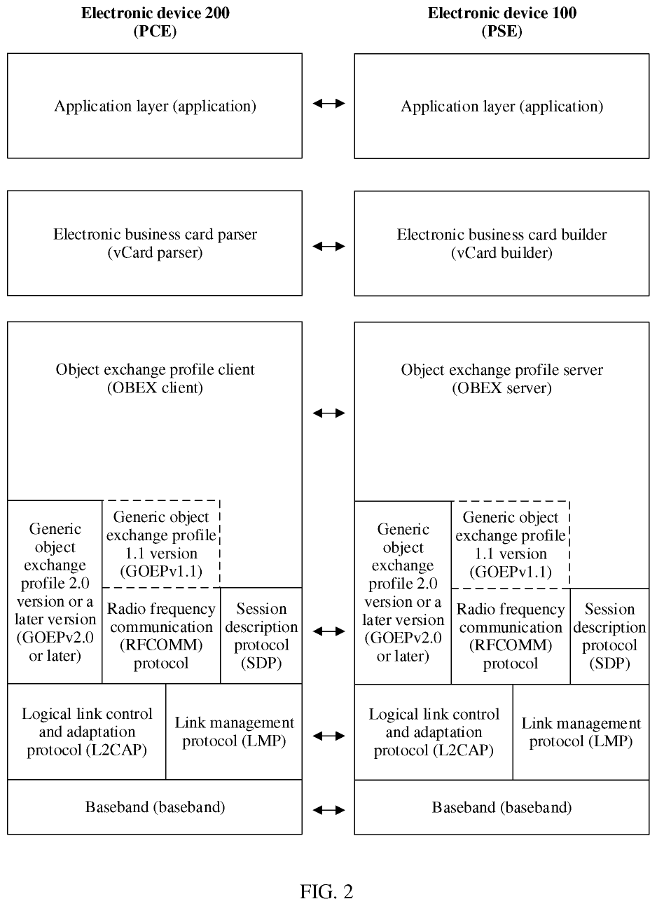

FIG. 2 shows an example of a Bluetooth protocol structure provided by the PCE and the PSE.

As shown in FIG. 2, the PCE may include: an application (application) layer, an electronic business card parser (vCard parser), an object exchange profile client (OBEX client), a generic object exchange profile 2.0 version or a later version (Generic Object Exchange Profile v2.0 or later, GOEPv2.0 or later), a generic object exchange profile 1.1 version (GOEPv1.1), a radio frequency communication (radio frequency communication, RFCOMM) protocol, a session description protocol (session description protocol, SDP), a logical link control and adaptation protocol (logical link control and adaptation protocol, L2CAP), a link management protocol (link management protocol, LMP), and a baseband (baseband).

As shown in FIG. 2, the PSE may include: an application layer (application), an electronic business card builder (vCard builder), an object exchange profile server (OBEX server), a generic object exchange profile 2.0 version or a later version (GOEPv2.0 or later), a generic object exchange profile 1.1 version (GOEPv1.1), a radio frequency communication (RFCOMM) protocol, a session description protocol (SDP), a logical link control and adaptation protocol (L2CAP), a link management protocol (LMP), and a baseband (baseband).

It can be seen from the Bluetooth protocol structure shown in FIG. 2 that, the PBAP profile is located at the application layer on the top, and then, the electronic business card builder/parser is responsible for data format processing. Because an address book is stored in the mobile phone in a vCard (versitCard) format, the electronic business card builder/parser performs data processing in the vCard format. Then, the radio frequency communication RFCOMM protocol in a Bluetooth protocol stack is connected by using the OBEX protocol layer, and finally, data is sent through a unified data transmission channel L2CAP link.

Currently, vCard has two versions: vCard 2.1 and vCard 3.0. Therefore, the PSE needs to support the two data formats. During data synchronization, the PSE needs to encapsulate data based on a data format requested by the PCE and transmit encapsulated data to the PCE. However, regardless of the data format, a character set of vCard attribute content uses a unique character coding utf-8 format for coding conversion.

If the PSE is an electronic device with a SIM card, for example, a mobile phone, the source data may be stored in a memory of the mobile phone, or may be stored in the SIM card. Therefore, more comprehensive consideration needs to be taken during data synchronization. For example, it needs to be specified whether data that needs to be synchronized is obtained from the memory of the mobile phone or the SIM card.

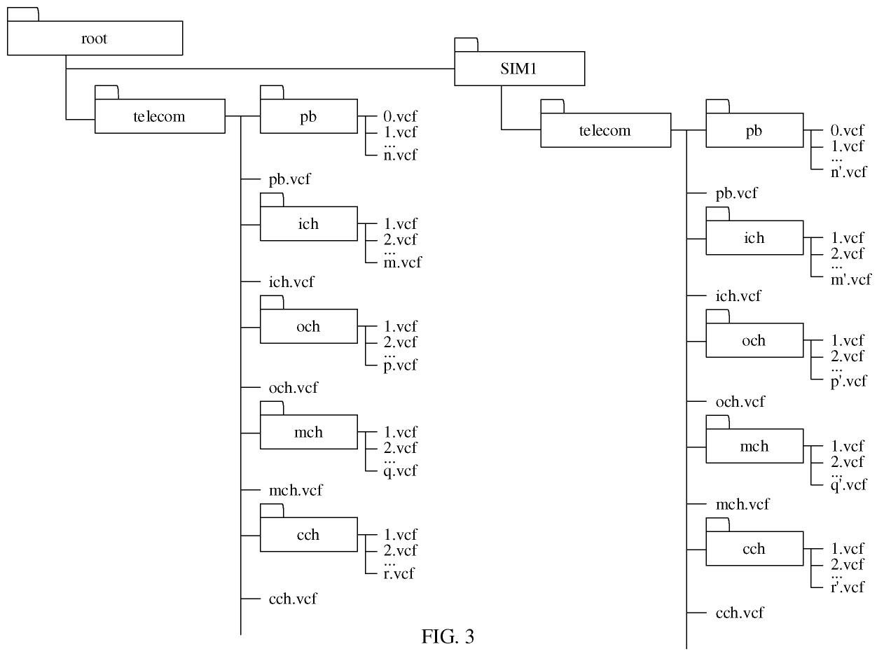

FIG. 3 shows an example of a storage form of source data (for example, address book data or call record data).

As shown in FIG. 3, it is assumed that a SIM card, for example, a SIM card 1, is installed on the mobile phone. When data synchronization is performed, a path from which corresponding data is obtained needs to be specified, that is, whether the data that needs to be synchronized is obtained from a memory path of the mobile phone or from a SIM card 1 path. It is easy to understand that, if the data that needs to be synchronized is obtained from the memory path of the mobile phone, the path that needs to be specified may be represented as telecom/xxx.vcf. If the data that needs to be synchronized is obtained from the SIM card 1 path, the path that needs to be specified may be represented as SIM1/telecom/xxx.vcf.

The source data may also be referred to as a phone book object. For related descriptions of phone book objects, refer to Table 1.

It can be easily seen that based on different synchronization paths and synchronized phone book objects, four common synchronization commands may be obtained: synchronizing an address book in a memory of a mobile phone, synchronizing a call record in the memory of the mobile phone, synchronizing an address book in the SIM card, and synchronizing a call record in the SIM card.

TABLE 1
Phone book object

| Object name | Abbreviation | Description | Remark | Storage file format |
|---|---|---|---|---|
| Phone book object | pb | Address book | Frequently | pb.vcf |
| Incoming calls | ich | Incoming call | used | ich.vcf |
| history object | | record | | |
| Outgoing calls | och | Outgoing call | | och.vcf |
| history object | | record | | |
| Missed calls | mch | Missed call record | | mch.vcf |
| history object | | | | |
| Combined calls | cch | All call records | | cch.vcf |
| history object | | | | |
| Speed-dial object | spd | Speed dial | Infrequently | spd.vcf |
| Favorite contacts | fav | Favorite contact | used | fav.vcf |
| object | | | | |

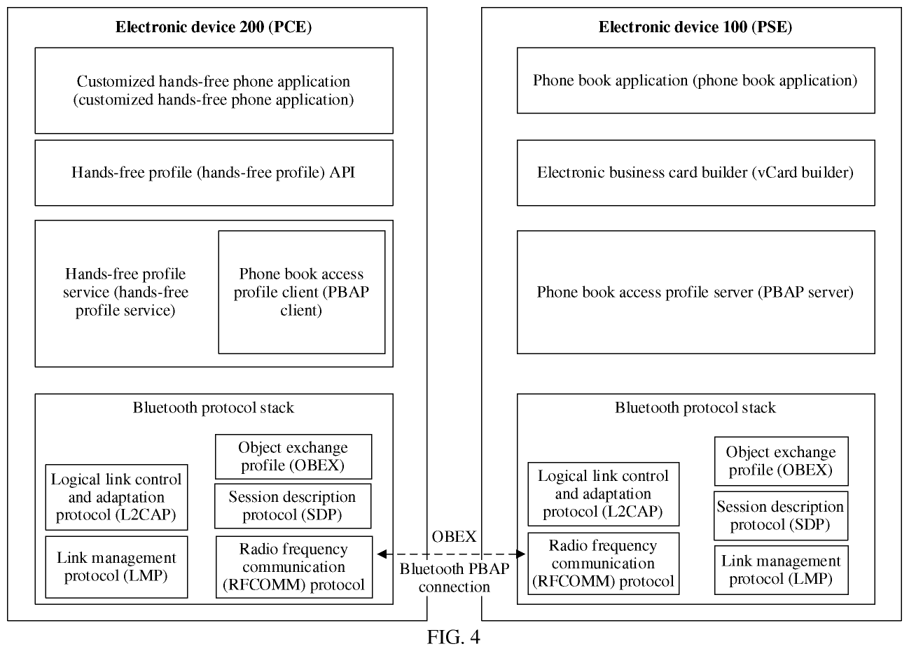

FIG. 4 shows an example of another Bluetooth protocol structure provided by the PCE and the PSE.

As shown in FIG. 4, the PCE may include: a customized hands-free phone application (customized hands-free phone application), a hands-free profile (hands-free profile, HFP) API, a hands-free profile service (hands-free profile service, HFP service), and a Bluetooth protocol stack. The hands-free profile service may include a PBAP client, and the Bluetooth protocol stack may include the OBEX profile, the SDP, the L2CAP, the LMP and the RFCOMM protocol.

As shown in FIG. 4, the PSE may include: a phone book application (phone book application), an electronic business card builder (vCard builder), a phone book access profile server (PBAP server), and a Bluetooth protocol stack. The Bluetooth protocol stack may include the OBEX profile, the SDP, the L2CAP, the LMP, and the RFCOMM protocol.

The PCE may use the OBEX profile to obtain, through the Bluetooth PBAP connection, the address book and information about the call record that are provided by the PSE.

Each type of protocol defines a related feature. Refer to Table 2. The PBAP profile mainly defines two features: a download feature and a browsing feature. The download feature is used to download all content of the phone book object, and the browsing feature is applicable to an application program that needs to browse a phone book through scrolling.

Refer to Table 2. C1 indicates that at least one of the download feature and the browsing feature is supported, and M indicates that both the download feature and the browsing feature need to be supported. It can be seen that the PCE needs to support at least one of the download feature and the browsing feature, and the PSE needs to support both the download feature and the browsing feature.

Because the download feature may be used to synchronize all content of the phone book object to the PCE, after obtaining data, the PCE may display the data on an interface of the PCE by using an application program like a Bluetooth phone, to browse information about the phone book through scrolling.

TABLE 2

| Feature | Supported by PCE | Supported by PSE |
|---|---|---|
| Download (download) | C1 | M |
| Browsing (browsing) | C1 | M |

The download feature is especially applicable to a scenario in which a capacity of the phone book stored at the PSE is large, and the PCE usually downloads the large-capacity data from the PSE and locally stores the large-capacity data. Refer to Table 3. A PullPhonebook function is used to download a phone book object in which the client is interested, and both the PCE and the PSE need to support the function.

TABLE 3

| | | Supported | Supported |
|---|---|---|---|
| | Function | by PCE | by PSE |
| Phone book download feature | PullPhonebook | M | M |
| (phone book download feature) | | | |

The PBAP profile is according to the OBEX profile. Therefore, the PullPhonebook function uses the request-response format, namely, a question-answer format, to transmit data.

Refer to Table 4. A request format may be a format shown in Table 4.

A value corresponding to ConnectionID in the name column is a connection ID number replied by the PSE in a PBAP connection instruction when the PCE and the PSE perform a PBAP connection. In a process of data interaction between the PSE and the PCE, the device is identified based on ConnectionID.

A value object name corresponding to a name in the name column is a corresponding file (for example, an address book file, an incoming call record file, an outgoing call record file, or a missed call record file) in Table 1.

Parameters (application parameters) set by the application in the name column may include PropertySelector (indicating information specifically included in replied data), Format (indicating an assembly format corresponding to the replied data, and the assembly format is related to the vCard version), MaxListCount (indicating a quantity of synchronized objects), ListStartOffset (indicating an offset of the synchronized object), and the like. The PSE may assemble data that needs to be replied based on the parameters.

TABLE 4

| Field/Header | Name | Value |
|---|---|---|
| Field | Opcode | GET (0x03 or 0x83) |
| Field | Packet length | Varies |
| Header | Connection ID | Varies |
| Header | Single response mode | 0x01 |
| Header | Single response mode param | 0x01 |
| Header | Name | Object name (*.vcf) |
| Header | Type | “x-bt/phonebook” |
| Header | Application parameters | |
| | PropertySelector | Varies |
| | Format | Varies |
| | MaxListCount | Varies |
| | ListStartOffset | Varies |
| | ResetNewMissedCalls | Varies |
| | vCardSelector | Varies |
| | vCardSelectorOperator | Varies |

TABLE 5

| Field/Header | Name | Value |
|---|---|---|
| Field | Response cde | 0x90 or 0xA0 or error code |
| Field | Packet length | Varies |
| Header | Single response mode | 0x01 |
| Header | Single response mode param | 0x01 |
| Header | Application parameters | |
| | PhonebookSize | Varies |
| | NewMissedCalls | Varies |
| | PrimaryFolderVersion | Varies |
| | SecondaryFolderVersion | Varies |
| | DatabaseIdentifier | Varies |
| Header | Body/End of body | vCard object(s) |

Refer to Table 5. A reply format may be a format shown in Table 5.

When MaxListCount in the request is o, a value corresponding to PhonebookSize in the name column in Table 5 may be returned, where the value corresponding to PhonebookSize may indicate a total quantity of files included in the phone book object of the PSE.

When MaxListCount in the request is not o, a file included in the phone book object may be returned, namely, a value vCard object (vCard object) corresponding to Body/End of body in the name column in Table 5, where vCard object in the data returned by the PSE includes only attributes indicated by the PropertySelector parameter, and the data is assembled in a format indicated by the Format parameter.

An important parameter in the request format and the reply format is an application parameters header, and data of the application parameters header is the entire application parameters including a group of different tags. A common tag is PropertySelector, and PropertySelector indicates attributes that need to be included in vCard object in the request. The PSE assembles data included in the replied Body/End of body header based on the attributes. The PCE may use the header to receive content required by requested vCard, and the PSE does not reply with other performance data unless the PCE has another requirement.

Because a value corresponding to PropertySelector includes 64-bit data, each bit indicates an attribute. If the address book object requested by the PCE needs to include corresponding data, a binary bit in PropertySelector corresponding to the data needs to be set to 1 (namely, true). For a specific meaning indicated by each bit, refer to Table 6.

TABLE 6

| Bit 0 | Version | vCardVersion |
|---|---|---|
| Bit 1 | FN | Formatted name |
| Bit 2 | N | Structured presentation of name |
| Bit 3 | PHOTO | Associated image or photo |
| Bit 4 | BDAY | Birthday |
| Bit 5 | ADR | Delivery address |
| Bit 6 | LABEL | Delivery |
| Bit 7 | TEL | Telephone number |
| Bit 8 | EMAIL | Electronic mail address |
| Bit 9 | MAILER | Electronic mail |
| Bit 10 | TZ | Time zone |
| Bit 11 | GEO | Geographic position |
| Bit 12 | TITLE | Job |
| Bit 13 | ROLE | Role within the organization |
| Bit 14 | LOGO | Organization logo |
| Bit 15 | AGENT | vCard of person representing |
| Bit 16 | ORG | Name of organization |
| Bit 17 | NOTE | Comments |
| Bit 18 | REV | Revision |
| Bit 19 | SOUND | Pronunciation of name |
| Bit 20 | URL | Uniform resource locator |
| Bit 21 | UID | Unique ID |
| Bit 22 | KEY | Public encryption key |
| Bit 23 | NICKNAME | Nickname |
| Bit 24 | CATEGORIES | Categories |
| Bit 25 | PROID | Product ID |
| Bit 26 | CLASS | Class information |
| Bit 27 | SORT-STRING | String used for sorting operations |
| Bit 28 | X-IRMC-CALL-DATETIME | Time stamp |
| Bit 29 | X-BT-SPEEDDIALKEY | Speed-dial shortcut |
| Bit 30 | X-BT-UCI | Uniform caller identifier |
| Bit 31 | X-BT-UID | Bluetooth contact unique identifier |
| Bit 32 to bit 38 | | Reserved for future use |
| Bit 39 | Proprietary filter | Indicates the usage of a proprietary filter |
| Bit 40 to bit 63 | | Reserved for proprietary filter usage |

Usually, when information in the phone book is synchronized, most concerned data is a name, number, and profile picture of a contact. The value corresponding to PropertySelector may be constructed based on an actual requirement of a business, and data required by a related application of the PCE is synchronized.

In the existing PBAP profile, a profile picture of a contact is usually not synchronized, and only a name and number of a contact are synchronized, to ensure a synchronization speed. Consequently, synchronized information is little.

### Embodiment 1

The following describes a data transmission method provided in embodiments of this application.

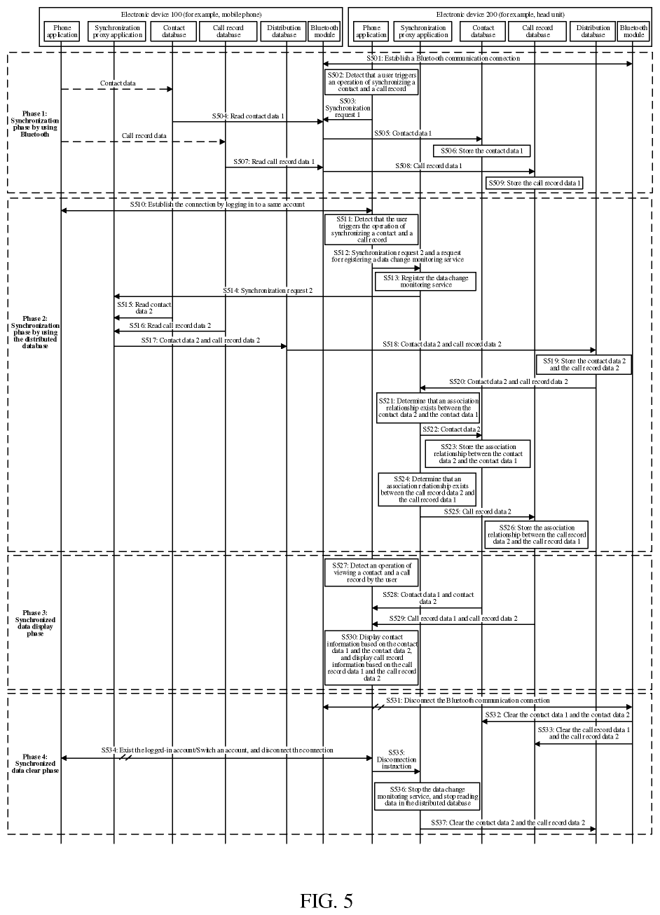

FIG. 5 shows an example of a specific procedure of a data transmission method according to an embodiment of this application.

As shown in FIG. 5, the method may be used in the communication system including the electronic device 100 and the electronic device 200. In an embodiment of this application, the electronic device 100 may be a mobile phone, and the electronic device 200 may be a head unit. The electronic device 100 may include a phone application, a synchronization proxy application, a contact database, a call record database, a distributed database, and a Bluetooth module. The electronic device 200 may include a phone application, a synchronization proxy application, a contact database, a call record database, a distributed database, and a Bluetooth module. The following describes in detail specific steps of the method.

### Phase 1: Synchronization Phase by Using Bluetooth

S501: The electronic device 100 establishes a Bluetooth communication connection to the electronic device 200.

Specifically, the electronic device 100 may establish the Bluetooth communication connection to the electronic device 200 by using the Bluetooth module of the electronic device 100 and the Bluetooth module of the electronic device 200.

S502 and S503: The phone application of the electronic device 200 detects an operation of triggering synchronization of a contact and a call record by a user, and then the phone application of the electronic device 200 may send a synchronization request 1 to the Bluetooth module of the electronic device 100.

Specifically, when the electronic device 100 is authorized to share information such as a contact (which may also be referred to as an address book) and a call record on the electronic device 100, the phone application of the electronic device 200 may detect the operation (for example, an operation of starting the phone application of the electronic device 200 by the user) of triggering synchronization of a contact and a call record by the user. Then, the phone application of the electronic device 200 may send the synchronization request 1 to the Bluetooth module of the electronic device 100 by using the Bluetooth module of the electronic device 200.

A request format of the synchronization request 1 may be the format shown in Table 4, and the synchronization request 1 may include indication information for requesting contact data, indication information for requesting call record data, and the like.

It should be noted that, in an embodiment of this application, both the phone application of the electronic device 100 and the phone application of the electronic device 200 are application programs that can implement a function of making a call and can provide information such as a contact and a call record. The application program may alternatively have another name, and this should not constitute any limitation.

In some embodiments, after the electronic device 100 establishes the Bluetooth communication connection to the electronic device 200, and the electronic device 100 is authorized to share the information such as the contact and the call record on the electronic device 100, the user does not need to trigger synchronization of a contact and a call record. However, the electronic device 100 may automatically synchronize the contact and the call record to the electronic device 200, or the electronic device 200 may automatically send the synchronization request 1 to the electronic device 100.

S504 to S506: The Bluetooth module of the electronic device 100 reads contact data 1 from the contact database of the electronic device 100, the Bluetooth module of the electronic device 100 may send the contact data 1 to the contact database of the electronic device 200, and after receiving the contact data 1, the contact database of the electronic device 200 may store the contact data 1.

Specifically, after receiving the synchronization request 1 sent by the electronic device 200, the Bluetooth module of the electronic device 100 may read the contact data 1 from the contact database of the electronic device 100. The contact data 1 may be data, for example, a name and a phone number of a contact, corresponding to a field that can be synchronized and that is specified in the existing PBAP profile.

After reading the contact data 1, the Bluetooth module of the electronic device 100 sends the contact data 1 to the contact database of the electronic device 200 by using the Bluetooth module of the electronic device 200, and after receiving the contact data 1, the contact database of the electronic device 200 may store the contact data 1.

The contact data 1 may be used to subsequently display, on the electronic device 200, contact information (for example, the name and the phone number of the contact) on the phone application of the electronic device 100.

It should be noted that all contact data (for example, the name, the phone number, and a profile picture of the contact) on the phone application of the electronic device 100 may be stored in the contact database of the electronic device 100 in advance. Therefore, in the foregoing step, the Bluetooth module of the electronic device 100 may read the contact data 1 from the contact database of the electronic device 100.

S507 to S509: The Bluetooth module of the electronic device 100 reads call record data 1 from the call record database of the electronic device 100, the Bluetooth module of the electronic device 100 may send the call record data 1 to the call record database of the electronic device 200, and after receiving the call record data 1, the call record database of the electronic device 200 may store the call record data 1.

Specifically, after receiving the synchronization request 1 sent by the electronic device 200, the Bluetooth module of the electronic device 100 may read the call record data 1 from the call record database of the electronic device 100. The call record data 1 may be data, for example, a phone name and a call status (for example, an incoming call record, an outgoing call record, and a missed call record), corresponding to a field that can be synchronized and that is specified in the existing PBAP profile.

After reading the call record data 1, the Bluetooth module of the electronic device 100 sends the call record data 1 to the call record database of the electronic device 200 by using the Bluetooth module of the electronic device 200, and after receiving the call record data 1, the call record database of the electronic device 200 may store the call record data 1.

The call record data 1 may be used to subsequently display, on the electronic device 200, call record information (for example, the phone number and the call status) on the phone application of the electronic device 100.

It should be noted that all call record data (for example, the phone number, SIM card information, a home location of an operator, yellow page information, and the call status) on the phone application of the electronic device 100 may be stored in the call record database of the electronic device 100 in advance. Therefore, in the foregoing step, the Bluetooth module of the electronic device 100 may read the call record data 1 from the call record database of the electronic device 100.

It should be noted that a time sequence of performing step S504 to step S506 and step S507 to step S509 is not limited in embodiments of this application. For example, step S504 to step S506 may also be performed after step S507 to step S509. For another example, step S504 to step S506 may alternatively be performed simultaneously with step S507 to step S509.

It should be noted that when the electronic device 100 establishes the Bluetooth communication connection to the electronic device 200, the electronic device 100 and the electronic device 200 may perform data synchronization by using Bluetooth according to the existing PBAP profile. It is easy to understand that due to a field limitation of the existing PBAP profile, synchronized contact data may include only information such as the name and the phone number of the contact, and the profile picture of the contact is not synchronized, to ensure a synchronization speed. In synchronized call record data, the PBAP profile includes three call record types: an incoming call record, an outgoing call record, and a missed call record, but does not include a call record type of a rejected incoming call record. The electronic device 100, for example, the mobile phone, may reject an incoming call, and include a rejected incoming call record. Therefore, in the PBAP profile, for the rejected incoming call record on the electronic device 100, the rejected incoming call record is usually forcibly converted into a missed call record.

Based on the foregoing problems, the following uses a method provided in a phase 2 to synchronize additional information. The additional information may include but is not limited to information such as the profile picture of the contact in the contact data, the SIM card information (namely, identification information of a SIM card) in the call record data, the home location of the operator, the yellow page information, and the call status.

### Phase 2: Synchronization Phase by Using a Distributed Database

S510: The electronic device 100 establishes the connection to the electronic device 200 by logging in to a same account.

Specifically, the electronic device 100 and the electronic device 200 may log in to the same account, for example, a same Huawei account. In this way, the electronic device 100 establishes the connection to the electronic device 200 by logging in to the same account.

It is easy to understand that after the electronic device 100 and the electronic device 200 log in to the same account, the phone application of the electronic device 100 and the phone application of the electronic device 200 also log in to the account, and establish a connection.

S511 and S512: The phone application of the electronic device 200 detects the operation of triggering synchronization of a contact and a call record by the user, and in response to the operation, the phone application of the electronic device 200 may send, to the synchronization proxy application of the electronic device 200, a synchronization request 2 and a request for registering a data change monitoring service.

Specifically, when the electronic device 100 establishes the connection to the electronic device 200 by logging in to the same account, the phone application of the electronic device 200 may detect the operation (for example, the operation of starting the phone application of the electronic device 200 by the user) of triggering synchronization of a contact and a call record by the user. Then, the phone application of the electronic device 200 may send, to the synchronization proxy application of the electronic device 200, the synchronization request 2 and the request for registering the data change monitoring service.

The synchronization request 2 may include the indication information for requesting contact data, the indication information for requesting call record data, and the like.

The request for registering the data change monitoring service indicates the synchronization proxy application of the electronic device 200 to monitor a change of data in the distributed database of the electronic device 200.

In some embodiments, after the electronic device 100 establishes the connection to the electronic device 200 by logging in to the same account, the user does not need to trigger synchronization of a contact and a call record. However, the electronic device 100 may automatically synchronize the contact and the call record to the electronic device 200, or the electronic device 200 may automatically send the synchronization request 2 to the electronic device 100.

S513: The synchronization proxy application of the electronic device 200 registers the data change monitoring service.

Specifically, after receiving the request for registering the data change monitoring service sent by the phone application of the electronic device 200, the synchronization proxy application of the electronic device 200 may register the data change monitoring service, to monitor the change of the data in the distributed database of the electronic device 200.

S514: The synchronization proxy application of the electronic device 200 sends the synchronization request 2 to the synchronization proxy application of the electronic device 100.

Specifically, after receiving the synchronization request 2 sent by the phone application of the electronic device 200, the synchronization proxy application of the electronic device 200 may initiate a synchronization service of the electronic device 100 by using a distributed execution framework (distributed execution framework, DEF). For example, the synchronization proxy application of the electronic device 200 may send the synchronization request 2 to the synchronization proxy application of the electronic device 100, to notify the electronic device 100 that data can be synchronized to the electronic device 200.

It should be noted that a time sequence of performing step S513 and step S514 is not limited in embodiments of this application. For example, step S513 may be performed after step S514 is performed. For another example, step S513 may be performed simultaneously with step S514.

In some embodiments, because there may be a plurality of electronic devices, except the electronic device 100, that log in to a same account as the electronic device 200, the synchronization proxy application of the electronic device 200 may first determine that an electronic device that currently establishes a Bluetooth connection to the electronic device 200 is an electronic device that logs in to the same account as the electronic device 200. For example, the synchronization proxy application of the electronic device 200 may query whether a media access control (media access control, MAC) address of the electronic device that currently establishes the Bluetooth connection to the electronic device 200 is a Bluetooth MAC address, for example, a Bluetooth MAC address of the electronic device 100, of the electronic device that logs in to the same account as the electronic device 200. If yes, the synchronization proxy application of the electronic device 200 may perform step S514 again, to initiate a synchronization service of the electronic device 100.

S515 and S516: The synchronization proxy application of the electronic device 100 reads contact data 2 from the contact database of the electronic device 100, and reads call record data 2 from the call record database of the electronic device 100.

Specifically, after the synchronization service of the electronic device 100 is initiated by the electronic device 200, for example, after the synchronization proxy application of the electronic device 100 receives the synchronization request 2 sent by the synchronization proxy application of the electronic device 200, the synchronization proxy application of the electronic device 100 may read the contact data 2 from the contact database of the electronic device 100, and read the call record data 2 from the call record database of the electronic device 100.

The contact data 2 may include but is not limited to the profile picture, the name, and the phone number of the contact.

The contact data 2 may be used to subsequently display, on the electronic device 200, contact information (for example, the name, the phone number, and the profile picture of the contact) on the phone application of the electronic device 100.

The call record data 2 may include but is not limited to the phone number, the SIM card information, the home location of the operator, the yellow page information, and the call status (for example, an incoming call record, an outgoing call record, a missed call record, and a rejected incoming call record).

The call record data 2 may be used to subsequently display, on the electronic device 200, call record information (for example, the phone number, the SIM card information, the home location of the operator, the yellow page information, and the call status) on the phone application of the electronic device 100.

In some embodiments, because the information synchronized in the phase 2 is mainly used to supplement information that is not synchronized in the Bluetooth synchronization phase in the phase 1, it is unnecessary to synchronize the information (for example, the name and the phone number of the contact) that has been synchronized in the Bluetooth synchronization phase again in the phase 2. For the contact data, to synchronize the profile picture of the contact, the contact data 2 may include the profile picture of the contact. For the call record data, to synchronize the SIM card information, the home location of the operator, the yellow page information, and information about the rejected incoming call record in the call status, the call record data may include the SIM card information, the home location of the operator, the yellow page information, and information about the rejected incoming call record in the call status.

S517 to S519: The synchronization proxy application of the electronic device 100 sends the contact data 2 and the call record data 2 to the distributed database of the electronic device 100 (that is, the contact data 2 and the call record data 2 are written into the distributed database of the electronic device 100); after receiving the contact data 2 and the call record data 2, the distributed database of the electronic device 100 may send the contact data 2 and the call record data 2 to the distributed database of the electronic device 200; and after receiving the contact data 2 and the call record data 2, the distributed database of the electronic device 200 may store the contact data 2 and the call record data 2.

Specifically, after reading the contact data 2 and the call record data 2, the synchronization proxy application of the electronic device 100 may perform format conversion on the contact data 2 and the call record data 2, and then may write the contact data 2 and the call record data 2 obtained through format conversion into the distributed database of the electronic device 100 (that is, the contact data 2 and the call record data 2 are sent to the distributed database of the electronic device 100). After receiving the contact data 2 and the call record data 2, the distributed database of the electronic device 100 may send the contact data 2 and the call record data 2 to the distributed database of the electronic device 200 by using a distributed data service (distributed data service, DDS). After receiving the contact data 2 and the call record data 2, the distributed database of the electronic device 200 may store the contact data 2 and the call record data 2.

The distributed data service (which may also be referred to as a distributed database technology) may provide an application program with a capability of distributing database data between different devices. The application program may store data in a distributed database by invoking a distributed data interface. The distributed data service can isolate data by combining a triplet of an account, an application program, and a database. The distributed data service supports data synchronization between devices on which trust authentication succeeds, and may provide the user with consistent data access experience on a plurality of types of terminal devices. A specific implementation of using the distributed data service to perform data synchronization in the phase 2 is described in detail in subsequent embodiments. Details are not described herein.

The distributed data service may perform data synchronization through a Wi-Fi channel (or another channel). This is not limited in embodiments of this application.

The distributed database is a non-relational database that may be jointly maintained by a plurality of devices when the plurality of devices log in to a same account. Data is usually stored and read in a form of a key-value pair (key-value). Therefore, format conversion may be performed on the contact data 2 and the call record data 2, and the contact data 2 and the call record data 2 are written into the distributed database of the electronic device 100 in a key-value form. The following separately describes processes of performing format conversion on the contact data 2 and the call record data 2.

### 1. Convert a Format of the Contact Data 2

Refer to Table 6. The original PBAP profile has a UID field. The field may be used to transfer a unique identifier rawContactId of contact data. In the original PBAP profile, the unique identifier is usually not synchronized by using Bluetooth. To ensure that the additional contact data synchronized by using the distributed database in the phase 2 matches the contact data synchronized by using Bluetooth in the phase 1, in the phase 1, when the contact data is synchronized by using Bluetooth and according to the PBAP profile, the UID field in the PBAP profile may also be used to transfer the unique identifier rawContactId of the contact data. After receiving the field, the electronic device 200 may store rawContactId in a sync1 field of the contact database. Therefore, the additional contact data (for example, the contact data 2) that is synchronized by using the distributed database in the phase 2 can match the contact data (for example, the contact data 1) that is synchronized by using Bluetooth.

In an embodiment of this application, the contact data 2 is written into the distributed database of the electronic device 100 in a key-value form, where a key may be rawContactId, and a value may be contact data in a vCard format.

For example, the contact data 2 includes a profile picture of a contact 1 and a profile picture of a contact 2, rawContactId corresponding to the profile picture of the contact 1 is rawContact1, and rawContactId corresponding to the profile picture of the contact 2 is rawContact2. If key1 is rawContact1, a value corresponding to key1 is the profile picture of the contact 1 in the vCard format. If key2 is rawContact2, a value corresponding to key2 is the profile picture of the contact 2 in the vCard format.

In some embodiments, a hash value obtained by performing hash (hash) calculation on a name of a contact and a phone number (name+phone number) corresponding to the name of the contact may alternatively be used as a value of a key, that is, the unique identifier may be a hash value. In this case, in the original PBAP profile, the unique identifier rawContactId does not need to be synchronized by using Bluetooth. A hash function used in the hash calculation process is not limited in embodiments of this application. For example, the hash function used in the hash calculation process may be MD5. It should be noted that because a same contact may correspond to a plurality of phone numbers, a plurality of hash values may be calculated as values of the key. For example, if the contact 1 corresponds to two phone numbers, the contact 1 corresponds to two hash values (for example, a hash value 1 and a hash value 2). In this case, key1 may be the hash value 1, a value corresponding to key is the profile picture of the contact 1 in the vCard format, key2 may be the hash value 2, and a value corresponding to key2 is also the profile picture of the contact 1 in the vCard format. Unique identification is performed in this manner. The electronic device 200 also needs to use the same hash function to perform hash (hash) calculation on the name of the contact and the phone number corresponding to the name of the contact that have been synchronized in the Bluetooth phase, to obtain a corresponding hash value, and then match the hash value obtained through calculation with the hash value synchronized from the distributed database. For example, if two hash values are the same, it indicates that contact data (for example, the profile picture of the contact) corresponding to the hash value synchronized from the distributed database is data corresponding to the name of the contact that has been synchronized in the Bluetooth phase.

It should be noted that when a hash value is used as a unique identifier, contact information cannot be modified in an entire synchronization process (including Bluetooth synchronization and distributed database synchronization). Once the contact information is modified, data synchronized by using Bluetooth may not match data synchronized by using the distributed database.

### 2. Convert a Format of the Call Record Data 2

In an embodiment of this application, the call record data 2 is written into the distributed database of the electronic device 100 in a key-value form, where a key may be a phone number (phone number), and a value may be call record data in a Json (JavaScriptObjectNotation) format.

For example, it is assumed that the call record data 2 includes a rejected incoming call record, and a phone number corresponding to the rejected incoming call record is a phone number 1. In this case, the key is the phone number 1, and a value corresponding to the key is a rejected incoming call record in the Json format.

S520: The synchronization proxy application of the electronic device 200 reads the contact data 2 and the call record data 2 that are stored in the distributed database of the electronic device 200.

Specifically, after the electronic device 100 synchronizes the contact data and the call record data to the distributed database of the electronic device 200, the synchronization proxy application of the electronic device 200 may read the contact data (for example, the contact data 2) and the call record data (for example, the call record data 2) that are stored in the distributed database of the electronic device 200.

It should be noted that the Bluetooth synchronization manner in the phase 1 and the distributed database synchronization manner in the phase 2 do not interfere with each other. In other words, after the Bluetooth synchronization manner is triggered, the electronic device 200 may start to synchronize contact data (for example, the contact data 1) and call record data (for example, the call record data 1) on the electronic device 100 by using Bluetooth. After the distributed database synchronization manner is triggered, the electronic device 200 may start to synchronize contact data (for example, the contact data 2) and call record data (for example, the call record data 2) on the electronic device 100 by using the distributed database. Because the distributed database synchronization process is not a process of synchronizing all contact data and all call record data at a time, but a process of continuous synchronization, the electronic device 200 does not need to read data after distributed database synchronization is completed. Instead, after Bluetooth synchronization is completed, the electronic device 200 may start to read data synchronized from the distributed database, and perform step S521 to step S526 to store, to a corresponding database, the data, as a supplement, that is associated with data that is synchronized by using Bluetooth. In addition, the electronic device 200 may further monitor a data change in the distributed database, read data when the data changes, and perform step S521 to step S526 to store, to the corresponding database, the data, as a supplement, that is associated with the data that is synchronized by using Bluetooth.

S521 to S523: The synchronization proxy application of the electronic device 200 determines that an association relationship exists between the contact data 2 and the contact data 1; the synchronization proxy application of the electronic device 200 sends the contact data 2 to the contact database of the electronic device 200 (that is, the contact data 2 is written into the contact database of the electronic device 200); and after receiving the contact data 2, the contact database of the electronic device 200 may store the association relationship between the contact data 2 and the contact data 1.

Specifically, after reading the contact data in the distributed database of the electronic device 200, the synchronization proxy application of the electronic device 200 may parse the read contact data. Further, the synchronization proxy application of the electronic device 200 may determine, based on a unique identifier (for example, rawContactId or a hash value) of the read contact data, which contact data in the contact database of the electronic device 200 is associated with the read contact data. For example, the read contact data is the contact data 2. The synchronization proxy application of the electronic device 200 may determine, based on a unique identifier (for example, rawContactId or a hash value) of the contact data 2, to determine that the contact data 2 is associated with the contact data 1 in the contact database of the electronic device 200 (that is, the contact data synchronized in the phase 2 matches the contact data synchronized in the Bluetooth synchronization phase in the phase 1).

Further, the synchronization proxy application of the electronic device 200 may convert the format of the contact data 2 into a data storage format corresponding to the contact database of the electronic device 200, and then write the contact data 2 into a corresponding location in the contact database of the electronic device 200. In this way, the contact database of the electronic device 200 may store the association relationship between the contact data 2 and the contact data 1. Therefore, the contact database of the electronic device 200 may store both the contact data (namely, the contact data 1) synchronized from the phase 1 by using Bluetooth and the contact data (namely, the contact data 2) synchronized in the phase 2.

S524 to S526: The synchronization proxy application of the electronic device 200 determines that an association relationship exists between the call record data 2 and the call record data 1; the synchronization proxy application of the electronic device 200 sends the call record data 2 to the call record database of the electronic device 200; and after receiving the call record data 2, the call record database of the electronic device 200 may store the association relationship between the call record data 2 and the call record data 1.

Specifically, after reading the call record data in the distributed database of the electronic device 200, the synchronization proxy application of the electronic device 200 may parse the read call record data. Further, the synchronization proxy application of the electronic device 200 may determine, based on a unique identifier (for example, a phone number) of the read call record data, which call record data in the call record database of the electronic device 200 is associated with the read call record data. For example, the read call record data is the call record data 2. The synchronization proxy application of the electronic device 200 may determine, based on a unique identifier (for example, a phone number) of the call record data 2, to determine that the call record data 2 is associated with the call record data 1 in the contact database of the electronic device 200 (that is, the call record data synchronized in the phase 2 matches the call record data synchronized in the Bluetooth synchronization phase in the phase 1).

Further, the synchronization proxy application of the electronic device 200 may convert the format of the call record data 2 into a data storage format corresponding to the call record database of the electronic device 200, and then write the call record data 2 into a corresponding location in the call record database of the electronic device 200. In this way, the call record database of the electronic device 200 may store the association relationship between the call record data 2 and the call record data 1. Therefore, the contact database of the electronic device 200 may store both the call record data (namely, the call record data 1) synchronized from the phase 1 by using Bluetooth and the call record data (namely, the call record data 2) synchronized in the phase 2.

It should be noted that a time sequence of performing step S521 to step S523 and step S524 to step S526 is not limited in embodiments of this application. For example, step S521 to step S523 may also be performed after step S524 to step S526. For another example, step S521 to step S523 may alternatively be performed simultaneously with step S524 to step S526.

Data synchronization in the phase 2 is implemented by using the distributed database technology. In some embodiments, another technology may alternatively be used to perform data synchronization. For example, socket (socket) communication may be used to perform data synchronization. Socket communication usually requires a server and a client. Therefore, if the electronic device 200 needs to synchronize data on the electronic device 100, the electronic device 100 may serve as a server to send data that needs to be synchronized to the electronic device 200, and the electronic device 200 may serve as a client to receive the data sent by the electronic device 100. When data synchronization is performed by using a technology other than the distributed database technology, the electronic device 100 and the electronic device 200 do not need to log in to a same account, and the electronic device 100 and the electronic device 200 do not need to include a distributed database.

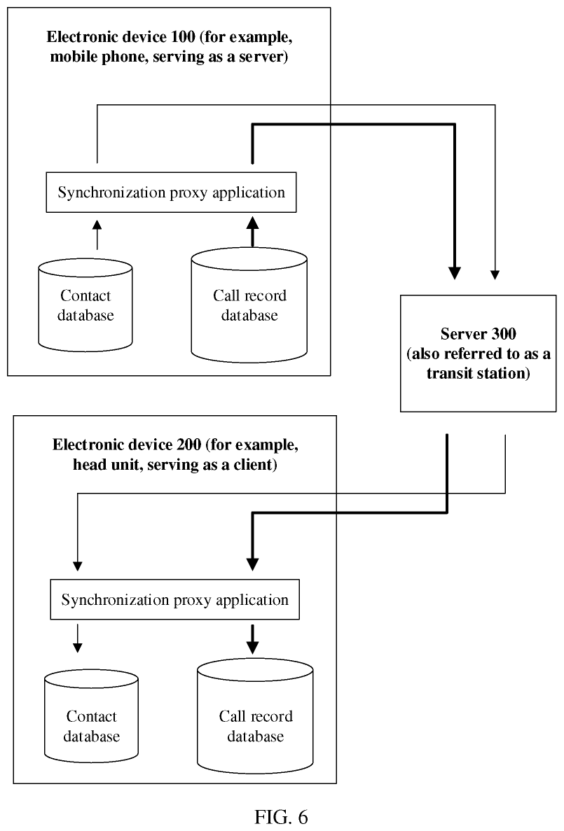

FIG. 6 is a diagram of interaction in a data synchronization process by using a socket according to an embodiment of this application.

As shown in FIG. 6, the synchronization proxy application of the electronic device 100 may separately read the contact data in the contact database and the call record data in the call record database. The contact data may carry the unique identifier (for example, rawContactId or a hash value), and the call record data may also carry the unique identifier (for example, a phone number). In this way, the electronic device 200 may match, based on the unique identifier, data synchronized in the Bluetooth synchronization phase with received data. Then, the synchronization proxy application of the electronic device 100 may send the contact data and the call record data to the synchronization proxy application of the electronic device 200 by using a server 300 (which may also be referred to as a transit station). After receiving the contact data and the call record data, the synchronization proxy application of the electronic device 200 may match, based on the unique identifier, the contact data and the call record data with the data synchronized in the Bluetooth synchronization phase. After matching is completed, the contact data may be written into a corresponding location in the contact database, and the call record data may be written into a corresponding location in the call record database, to complete supplementation of the data associated with the data synchronized in the Bluetooth synchronization phase.

It should be noted that in a process of performing data synchronization by using the socket, both the electronic device 100 and the electronic device 200 need to be in a network-connected state. In this way, data synchronization can be performed as long as a network is connected. In this process, data integrity and security need to be ensured, and a data transmission rate is also determined by the network. Compared with another solution, the solution that uses the socket to synchronize data is more universal and more flexible, but requires more development investment.

### Phase 3: Synchronized Data Display Phase

S527 to S530: The phone application of the electronic device 200 detects an operation of viewing a contact and a call record by the user; the phone application of the electronic device 200 may read the contact data 1 and the contact data 2, and read the call record data 1 and the call record data 2; and the phone application of the electronic device 200 may display the contact information based on the contact data 1 and the contact data 2, and display the call record information based on the call record data 1 and the call record data 2.

The following first describes an example of a user interface on which the electronic device 200 displays synchronized data when the electronic device 200 synchronizes the contact data and the call record data on the electronic device 100 only by using Bluetooth (that is, the contact data 1 and the call record data 1 on the electronic device 100 are synchronized by using the phase 1).

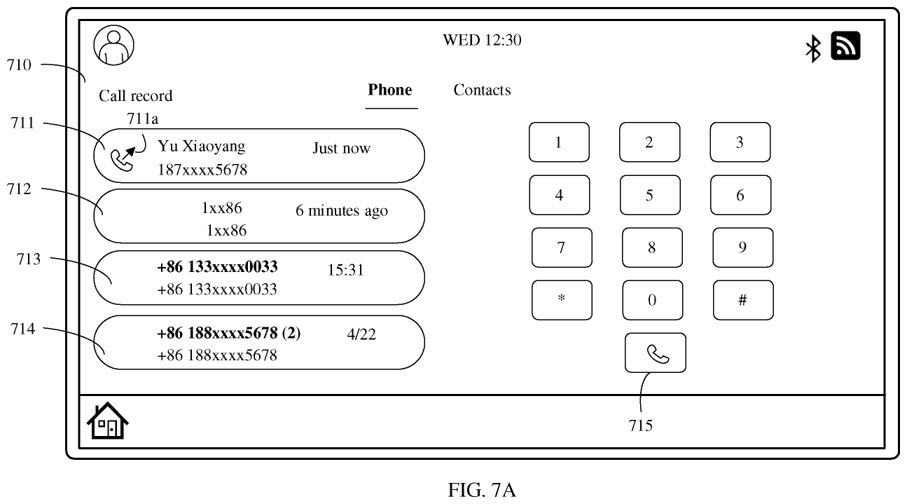

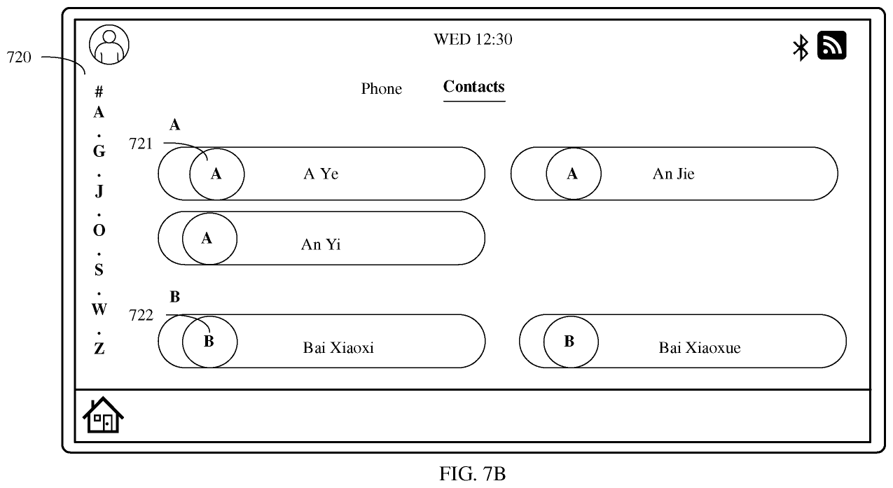

FIG. 7A is an example of a user interface 710 displayed after the phone application of the electronic device 200 detects an operation of viewing a call record by the user.

As shown in FIG. 7A, the user interface 710 includes four call records: a call record 711, a call record 712, a call record 713, and a call record 714. It is easy to understand that information displayed in the four call records is generated by the phone application of the electronic device 200 based on the call record data 1 that is read by the phone application of the electronic device 200 from the call record database of the electronic device 200. The read call record data 1 is obtained by the electronic device 200 from the electronic device 100 in the phase 1 according to the PBAP profile and by using Bluetooth.

Still refer to FIG. 7A. It is assumed that the call record 711 is an outgoing call record, the call record 712 is an answered call record, the call record 713 is a rejected incoming call record, and the call record 714 is a missed call record. Two rows of information may be displayed in each call record. The first row may display a name or a phone number of a contact. When the phone number in the call record is a known number (that is, when the user adds the phone number to an address book), the first row may display the name of the contact (for example, a name of a contact “Yu Xiaoyang” displayed in the first row of the call record 711). When the phone number in the call record is an unknown number (that is, when the user does not add the phone number to the address book), the first row may display the phone number (for example, a phone number “+86 133xxxx0033” displayed in the first row of the call record 713, and a phone number “+86 188xxxx5678” displayed in the first row of the call record 714). The second row may display a phone number (for example, a phone number “187xxxx5678” displayed in the second row of the call record 711, a phone number “1xx86” displayed in the second row of the call record 712, the phone number “+86 133xxxx0033” displayed in the second row of the call record 713, and the phone number “+86 188xxxx5678” displayed in the second row of the call record 714).

As shown in FIG. 7A, for an outgoing call record (for example, the call record 711), an identifier 711a may further be displayed in the call record, to indicate that the call record is an outgoing call record. Font colors, for example, black, of two rows of text information (for example, the first row “Yu Xiaoyang” and the second row “187xxxx5678”) may be preset by a system. For an answered incoming call record (for example, the call record 712), an identifier indicating that the call record is an answered incoming call record may not be displayed in the call record. Font colors, for example, black, of two rows of text information (for example, the first row “1xx86” and the second row “1xx86”) may be consistent with the font color of the outgoing call record. For a rejected incoming call record (the call record 713) and a missed call record (the call record 714), an identifier indicating that the call record is a rejected incoming call record/missed call record may not be displayed in the call record. Fonts (for example, a font color may be red) of two rows of text information (for example, the first row “+86 133xxxx0033” in the rejected incoming call record, and the first row “+86 188xxxx5678” in the missed call record) may be different from fonts of the outgoing call record and the answered incoming call record.

Still refer to FIG. 7A. The user interface 710 may further display an option 715, used to support the user in performing a call business.

It can be seen from FIG. 7A that when the electronic device 200 synchronizes the call record data of the electronic device 100 only by using Bluetooth, information displayed in the call record is little (for example, only a name or a phone number of a contact are displayed), and the SIM card information, the home location of the operator, the yellow page information, and the like are not displayed in the call record. In addition, a display manner of a rejected incoming call record is the same as that of a missed call record, and the user cannot distinguish the rejected incoming call record from the missed call record on the electronic device 200, which causes poor experience.

FIG. 7B is an example of a user interface 720 displayed after the phone application of the electronic device 200 detects an operation of viewing a contact by the user.

As shown in FIG. 7B, the user interface 720 may include information about one or more contacts, and the information about the one or more contacts may include names of the one or more contacts (for example, “A Ye”, “An Jie”, “An Yi”, “Bai Xiaoxi”, and “Bai Xiaoxue”). It is easy to understand that the information about the one or more contacts is generated by the phone application of the electronic device 200 based on the contact data 1 that is read by the phone application of the electronic device 200 from the contact database of the electronic device 200. The read contact data 1 is obtained by the electronic device 200 from the electronic device 100 in the phase 1 according to the PBAP profile and by using Bluetooth.

Still refer to FIG. 7B. The user interface 720 may further include one or more identifiers (for example, an identifier 721 and an identifier 722), where the one or more identifiers indicate a profile picture of a contact. It can be seen that the one or more identifiers are generated and displayed by the system by default. For example, if an initial letter of a name of a contact is A, A (for example, the identifier 721) is displayed on a corresponding identifier. If an initial letter of a name of a contact is B, B (for example, the identifier 722) is displayed on a corresponding identifier. The rest can be deduced by analogy. The one or more identifiers are not generated by the electronic device 200 based on the contact data 1 read by the electronic device 200 from the contact database of the electronic device 200. Due to a Bluetooth synchronization rate, the contact data 1 does not include data that occupies large bandwidth, for example, related data used to generate a profile picture of a contact. Therefore, the user interface 720 does not display a profile picture set by each contact.

The following describes an example of a user interface on which the electronic device 200 displays synchronized data when the electronic device 200 synchronizes the contact data and the call record data on the electronic device 100 by using Bluetooth (that is, the contact data 1 and the call record data 1 on the electronic device 100 are synchronized by using the phase 1) and another data synchronization manner (that is, the contact data 2 and the call record data 2 on the electronic device 100 are synchronized by using the phase 2).

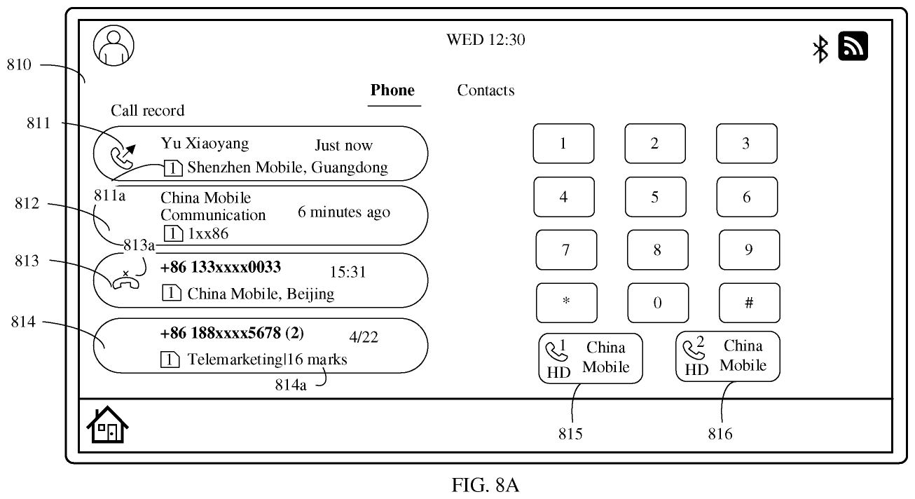

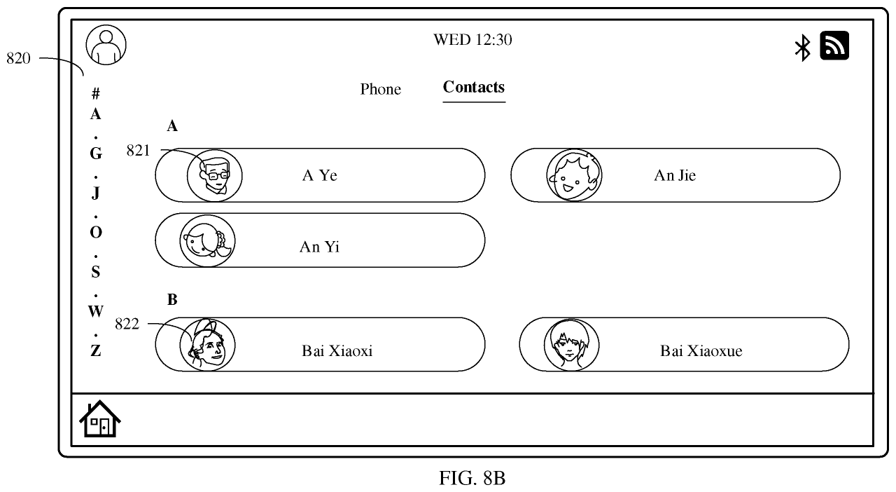

FIG. 8A is an example of a user interface 810 displayed after the phone application of the electronic device 200 detects an operation of viewing a call record by the user.

As shown in FIG. 8A, the user interface 810 includes four call records: a call record 811, a call record 812, a call record 813, and a call record 814. It is easy to understand that information displayed in the four call records is generated by the phone application of the electronic device 200 based on the call record data 1 and the call record data 2 that are read by the phone application of the electronic device 200 from the call record database of the electronic device 200. The read call record data 1 is obtained by the electronic device 200 from the electronic device 100 in the phase 1 according to the PBAP profile and by using Bluetooth, and the read call record data 2 is obtained by the electronic device 200 from the electronic device 100 in the phase 2 by using another data synchronization manner (for example, the distributed database technology).

Still refer to FIG. 8A. It is assumed that the call record 811 is an outgoing call record, the call record 812 is an answered call record, the call record 813 is a rejected incoming call record, and the call record 814 is a missed call record. It can be seen that information displayed in the call record in FIG. 8A is richer than the information displayed in the call record in FIG. 7A. For example, the first row of the call record may display yellow page information (for example, “China Mobile Communication” in the call record 812). The second row of the call record may display SIM card information (for example, an identifier 811a in the call record 811, to indicate that the call record 811 is generated by an SIM card 1 of the electronic device 100), display a home location of an operator (for example, “Shenzhen Mobile, Guangdong” in the call record 811, and “China Mobile, Beijing” in the call record 813), and further display mark information (for example, mark information 814a in the call record 814, to indicate that a phone number in the call record 814 is a phone number of a telemarketing type). In addition, the call record displayed in FIG. 8A may distinguish a rejected incoming call record from a missed call record. For the rejected incoming call record, for example, the call record 813, an identifier 813a may be displayed in the call record 813, to indicate that the call record 813 is a rejected incoming call record, so that a call status can be corrected. In other words, in FIG. 7A, the call record 713 in which the rejected incoming call record is incorrectly displayed as a missed call record is corrected and displayed as a rejected incoming call record.

In this way, a rule of the call record displayed by the electronic device 200 can be consistent with a rule of the call record displayed by the electronic device 100, to improve user experience.

Still refer to FIG. 8A. The user interface 810 may further display an option 815 and an option 816, to support the user in performing a call business. The option 815 may be used to support the user in performing a call business by using the SIM card 1, and the option 816 may be used to support the user in performing a call business by using a SIM card 2. A specific implementation is described in detail in subsequent embodiments. Details are not described herein.

FIG. 8B is an example of a user interface 820 displayed after the phone application of the electronic device 200 detects an operation of viewing a contact by the user.

As shown in FIG. 8B, the user interface 820 may include information about one or more contacts, and the information about the one or more contacts may include names of the one or more contacts (for example, “A Ye”, “An Jie”, “An Yi”, “Bai Xiaoxi”, and “Bai Xiaoxue”). It is easy to understand that the information about the one or more contacts may be generated by the phone application of the electronic device 200 based on the contact data 1 that is read by the phone application of the electronic device 200 from the contact database of the electronic device 200. The read contact data 1 is obtained by the electronic device 200 from the electronic device 100 in the phase 1 according to the PBAP profile and by using Bluetooth.

Still refer to FIG. 8B. The user interface 820 may further include one or more identifiers (for example, an identifier 821 and an identifier 822). The one or more identifiers indicate a profile picture of a contact. It can be seen that, different from the identifiers in FIG. 7B, the one or more identifiers are not generated and displayed by the system by default, but are set by each contact. The one or more identifiers are generated by the phone application of the electronic device 200 based on the contact data 2 that is read by the phone application of the electronic device 200 from the contact database of the electronic device 200. The read contact data 2 is obtained by the electronic device 200 from the electronic device 100 in the phase 2 by using another data synchronization manner (for example, the distributed database technology).

In this way, when synchronization is performed by using Bluetooth, synchronization is simultaneously performed by using another data synchronization manner (for example, the distributed database technology), and a synchronization rate is no longer limited by Bluetooth. When the synchronization rate is ensured and a normal function is not affected, data such as a profile picture of a contact that occupies large bandwidth may also be synchronized. This improves user experience.

### Phase 4: Synchronized Data Clear Phase

S531 to S533: The Bluetooth communication connection between the electronic device 100 and the electronic device 200 is disconnected, and then the Bluetooth module of the electronic device 200 may clear the contact data 1 and the contact data 2 that are stored in the contact database of the electronic device 200, and clear the call record data 1 and the call record data 2 that are stored in the call record database of the electronic device 200.

Specifically, after the Bluetooth communication connection between the electronic device 100 and the electronic device 200 is disconnected, the Bluetooth module of the electronic device 200 may search, based on device information (for example, a device identifier) of the electronic device 100, for the contact data, namely, the contact data 1 and the contact data 2, of the electronic device 100 that is stored in the contact database of the electronic device 200, and then may clear the contact data 1 and the contact data 2.

Similarly, after the Bluetooth communication connection between the electronic device 100 and the electronic device 200 is disconnected, the Bluetooth module of the electronic device 200 may also search, based on the device information (for example, a device identifier) of the electronic device 100, for the call record data, namely, the call record data 1 and the call record data 2, of the electronic device 100 that is stored in the call record database of the electronic device 200, and then may clear the call record data 1 and the call record data 2.

S534 to S537: After the phone application of the electronic device 200 exits the logged-in account or switches an account, the electronic device 100 is disconnected from the electronic device 200; the phone application of the electronic device 200 may send a disconnection instruction to the synchronization proxy application of the electronic device 200; and after receiving the disconnection instruction, the synchronization proxy application of the electronic device 200 may stop the data change monitoring service, stop reading the data in the distributed database of the electronic device 200, and clear the contact data 2 and the call record data 2 that are stored in the distributed database of the electronic device 200.

Specifically, after the electronic device 200 exits the logged-in account (for example, a Huawei account) or switches an account, the phone application of the electronic device 200 also exits the logged-in account (for example, a Huawei account) or switches an account. Therefore, the electronic device 100 is disconnected from the electronic device 200. Further, the phone application of the electronic device 200 may send the disconnection instruction to the synchronization proxy application of the electronic device 200. After receiving the disconnection instruction, the synchronization proxy application of the electronic device 200 may stop the data change monitoring service (that is, stop monitoring a data change), stop reading the data in the distributed database of the electronic device 200, and clear the contact data 2 and the call record data 2 that are stored in the distributed database of the electronic device 200.

It is easy to understand that after the electronic device 100 exits the logged-in account (for example, a Huawei account) or switches an account, the electronic device 100 is disconnected from the electronic device 200. Further, the synchronization proxy application of the electronic device 200 stops the data change monitoring service (that is, stop monitoring a data change), stops reading the data in the distributed database of the electronic device 200, and clears the contact data 2 and the call record data 2 that are stored in the distributed database of the electronic device 200.

The method provided in an embodiment shown in FIG. 5 is implemented. On a basis of information synchronization between a mobile phone and a head unit by using Bluetooth in the existing PBAP profile, additional information (for example, a profile picture of a contact in an address book, SIM card information in a call record, a home location of an operator, yellow page information, and a call status) is synchronized by using the distributed data service technology (which may also be referred to the distributed database technology), so that richer information of the mobile phone can be synchronized to the head unit when a synchronization speed and normal usage are ensured. This improves user experience.

It should be noted that, in FIG. 5, the synchronization proxy application of the electronic device 100 and the synchronization proxy application of the electronic device 200 may each be an application program for data synchronization or a functional module for data synchronization. This is not limited in embodiments of this application. The contact database, the call record database, and the distributed database of the electronic device 100 may be different databases, may be a same database, or may be a database obtained by combining any two databases. This is not limited in embodiments of this application. The contact database, the call record database, and the distributed database of the electronic device 200 may be different databases, may be a same database, or may be a database obtained by combining any two databases. This is not limited in embodiments of this application.

### Embodiment 2

In an existing Bluetooth call technology of the head unit, in a scenario in which dual SIM cards are installed in the mobile phone, the head unit does not display a call option corresponding to each SIM card, but displays only one call option (for example, the option 715 shown in FIG. 7A). Refer to FIG. 7A. If the user wants to perform a call business on the head unit, the user may tap the option 715. Then, the mobile phone may display a user interface for selecting a SIM card to perform a call business, and the call business may be performed after the user completes selection. It can be easily seen that user experience of this operation is poor. After the user triggers a call on the head unit, the user further needs to use the mobile phone to select a SIM card. Consequently, the user is distracted, and a security risk is high.

To resolve the foregoing problem, the head unit may synchronize information about the SIM card (for example, identifier information of the SIM card, a phone number corresponding to the SIM card, and a home location of an operator) on the mobile phone, so that a user can select a SIM card on the head unit to perform a call business. This improves user experience.

Possible implementations of synchronizing the information about the SIM card on the mobile phone to the head unit include but are not limited to the following two types:
Possible implementation 1: Synchronize the information about the SIM card on the mobile phone to the head unit by using a distributed database technology

In this implementation, the information about the SIM card may be simultaneously synchronized when the contact data (for example, the contact data 2) and the call record data (for example, the call record data 2) are synchronized by using the distributed database technology in the phase 2.

Specifically, it is assumed that the electronic device 100 is a mobile phone, and the electronic device 200 is a head unit. The synchronization proxy application of the electronic device 100 may read the information about the SIM card (for example, information about the SIM card 1 and information about the SIM card 2) of the electronic device 100, and write the information about the SIM card of the electronic device 100 into the distributed database of the electronic device 100. When the electronic device 100 and the electronic device 200 log in to the same account to establish the connection, the distributed database of the electronic device 100 may send the information about the SIM card of the electronic device 100 to the distributed database of the electronic device 200 by using the distributed data service (distributed data service, DDS). After receiving the information about the SIM card of the electronic device 100, the distributed database of the electronic device 200 may store the information about the SIM card of the electronic device 100. Further, the synchronization proxy application of the electronic device 200 may read the information about the SIM card of the electronic device 100 from the distributed database of the electronic device 200, and store the information about the SIM card of the electronic device 100 in a persistent medium (for example, preferences) of the electronic device 200. In this way, when the user needs to perform a call business on the electronic device 200, the electronic device 200 may read the stored information about the SIM card of the electronic device 100, to support the user in selecting a corresponding SIM card to perform the call business.
Possible implementation 2: Synchronize the information about the SIM card on the mobile phone to the head unit by using a socket communication manner

In this implementation, the information about the SIM card may be simultaneously synchronized when the contact data (for example, the contact data 2) and the call record data (for example, the call record data 2) are synchronized by using the socket communication manner in the phase 2.

Specifically, it is assumed that the electronic device 100 is a mobile phone, and the electronic device 200 is a head unit. When both the electronic device 100 and the electronic device 200 are connected to the network, the synchronization proxy application of the electronic device 100 may read the information about the SIM card (for example, information about the SIM card 1 and information about the SIM card 2) of the electronic device 100, and send the information about the SIM card of the electronic device 100 to the synchronization proxy application of the electronic device 200 in the socket communication manner. After receiving the information about the SIM card of the electronic device 100, the synchronization proxy application of the electronic device 200 may store the information about the SIM card of the electronic device 100 in a persistent medium (for example, preferences) of the electronic device 200. In this way, when the user needs to perform a call business on the electronic device 200, the electronic device 200 may read the stored information about the SIM card of the electronic device 100, to support the user in selecting, on the electronic device 200, a corresponding SIM card to perform the call business.

For a specific implementation process and a principle of the socket communication manner, refer to related descriptions in the conventional technology. Details are not described herein.

After the electronic device 200 (for example, the head unit) synchronizes the information about the SIM card of the electronic device 100 (for example, the mobile phone), the user may select, on the electronic device 200, a SIM card to perform the call business.

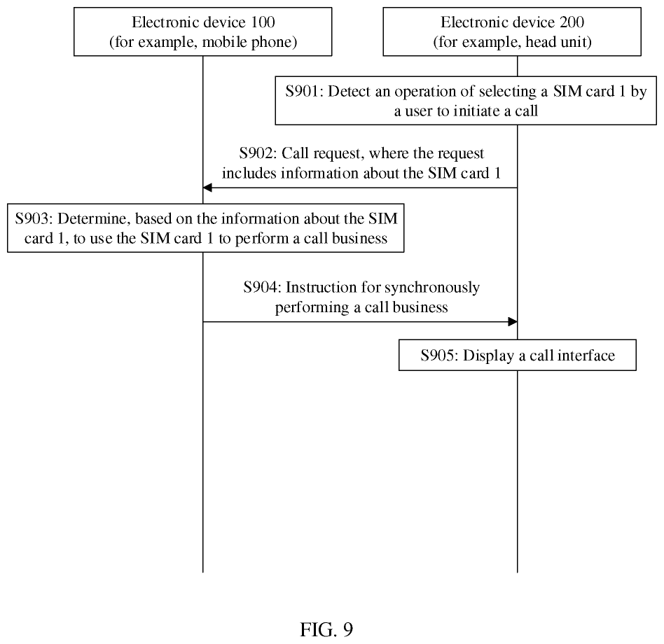

FIG. 9 shows an example of a specific procedure in which the user selects, on the electronic device 200, a SIM card to perform a call business according to an embodiment of this application. The following describes in detail specific steps.

S901 and S902: The electronic device 200 detects an operation of selecting the SIM card 1 by the user to initiate a call, and in response to the operation, the electronic device 200 may send a call request to the electronic device 100, where the request may include the information about the SIM card 1.

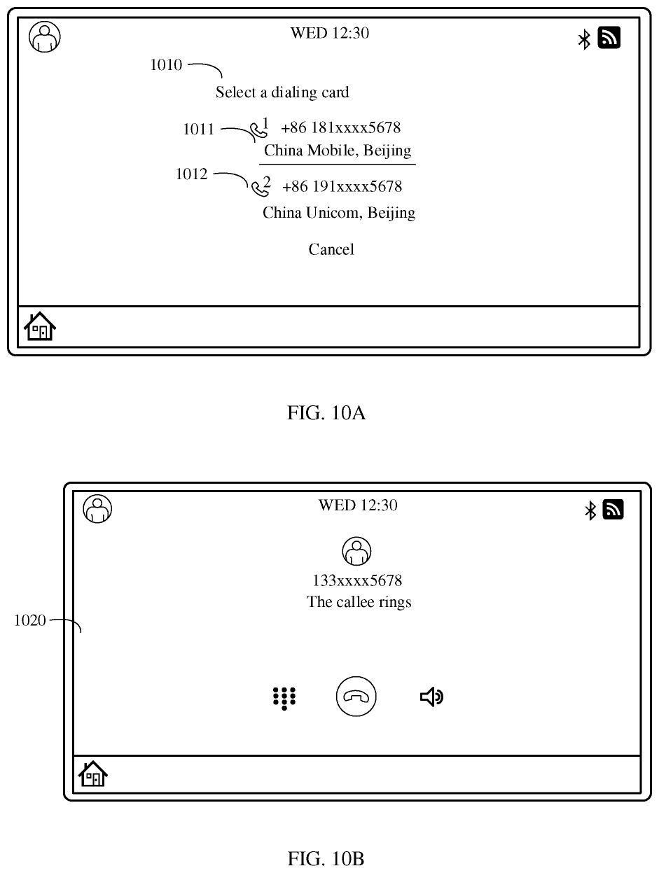

For example, the electronic device 200 synchronizes the information about the SIM card of the electronic device 100. It is assumed that the user expects to perform a call business. After the user triggers a call to a contact that has been added to the address book or triggers a call to an unknown phone number, the electronic device 200 may display a window 1010 shown in FIG. 10A. The window 1010 may include options (for example, an option 1011 and an option 1012) corresponding to the information about the SIM card of the electronic device 100. For example, the option 1011 displays the information about the SIM card 1 (for example, identification information of the SIM card 1, a phone number “+86 181xxxx5678” corresponding to the SIM card 1, and a home location “China Mobile, Beijing” of an operator), and the option 1012 displays the information about the SIM card 2 (for example, identification information of the SIM card 2, a phone number “+86 191xxxx5678” corresponding to the SIM card 2, and a home location “China Unicom, Beijing” of an operator). If the user expects to select the SIM card 1 to initiate a call, the electronic device 200 may detect an operation (for example, a tap operation) of the user on the option 1011. In response to the operation, the electronic device 200 may send a call request to the electronic device 100, to indicate the electronic device 100 to perform a call business by using the SIM card 1.

Refer to FIG. 8A. The electronic device 200 may also generate an option 815 and an option 816 based on the information about the SIM card of the electronic device 100. The option 815 is generated based on the information about the SIM card 1 of the electronic device 100, and is used by the user to perform a call business by using the SIM card 1. The option 816 is generated based on the information about the SIM card 2 of the electronic device 100, and is used by the user to perform a call business by using the SIM card 2.

If the user expects to call a phone number by using a SIM card, the user may enter the phone number in a phone number keypad in FIG. 8A, and then tap an option corresponding to the corresponding SIM card. For example, if the user expects to call a phone number by using the SIM card 1, the user may enter the phone number, and then tap the option 815 (that is, the option corresponding to the SIM card 1). After the user taps the option 815, the electronic device 200 may send the call request to the electronic device 100, to indicate the electronic device 100 to perform the call business by using the SIM card 1.

The call request may further include information (for example, a phone number, and a name of a contact stored in the address book) about a target call user (a user to which the user of the electronic device 200 expects to trigger a call), so that the electronic device 100 may learn which phone number the user expects to call, and further initiate a call to the phone number by using the SIM card selected by the user.

A possible implementation in which the electronic device 200 sends the call request to the electronic device 100 includes but is not limited to the following two implementations:

### Possible Implementation 1

The electronic device 200 may send the call request to the electronic device 100 by using a distributed service (for example, a distributed execution framework). For example, the electronic device 200 may send the call request to the electronic device 100 by using an ohos.extra.SLOT_ID field of a parameter Bundle in a placeCall interface.

### Possible Implementation 2

The electronic device 200 may send the call request to the electronic device 100 in the socket communication manner.

S903: The electronic device 100 determines, based on the information about the SIM card 1, to use the SIM card 1 to perform a call business.

Specifically, after receiving the call request sent by the electronic device 200, the electronic device 100 may determine, based on the information about the SIM card that is carried in the call request, which SIM card is used to perform the call business. For example, if the call request carries the information about the SIM card 1, the electronic device 100 may determine, based on the information about the SIM card 1, to use the SIM card 1 to perform the call business. Further, the electronic device 100 may use the SIM card 1 to perform the call business.

S904 and S905: The electronic device 100 sends an instruction for synchronously performing a call business to the electronic device 200, and after receiving the instruction, the electronic device 200 may display a call screen.

Specifically, after the electronic device 100 determines, based on the information about the SIM card 1, to use the SIM card 1 to perform the call business, the electronic device 100 may send the instruction for synchronously performing a call business to the electronic device 200. After receiving the instruction, the electronic device 200 may display the call screen.

For example, if the user expects to call a phone number “133xxxx5678”, the electronic device 200 may display a call screen 1020 shown in FIG. 10B as an example.

The instruction for synchronously performing a call business may be sent by using the distributed service or in the socket communication manner. This is not limited in embodiments of this application.

In this way, the user can select, on the electronic device 200, a SIM card of the electronic device 100 to perform a call business. This simplifies a user operation, improves user experience, and reduces a security risk of the user during driving.

### Embodiment 3

After data synchronization is completed according to the existing PBAP profile and by using Bluetooth, if data (for example, the contact data and the call record data) on the mobile phone is modified, data that has been synchronized to the head unit is not updated accordingly. In other words, currently, the head unit cannot refresh the synchronized data in real time.

Based on the foregoing problem, embodiments of this application provide the following two solutions on a basis of maintaining an original synchronization feature.

### Solution 1: Automatically Monitor a Data Change in the Database to Update Data in Real Time

Specifically, it is assumed that the electronic device 100 is a mobile phone, and the electronic device 200 is a head unit. The electronic device 100 may automatically monitor a data change in the database. When detecting that the user changes data (for example, the contact data and the call record data) in the electronic device 100, the electronic device 100 may perform an operation like insertion or changing on the distributed database. In this way, the data in the distributed database of the electronic device 100 changes. Further, the electronic device 100 may trigger a synchronization action of the distributed database, that is, the electronic device 100 may synchronize the data in the distributed database to the distributed database of the electronic device 200. After synchronization is completed, because the electronic device 200 may also monitor the distributed database, once detecting that the data in the distributed database of the electronic device 200 changes, the electronic device 200 may refresh data in a corresponding database (for example, the contact database and the call record database), to implement a function of refreshing data in real time.

### Solution 2: Manually Trigger Data Refresh by the User

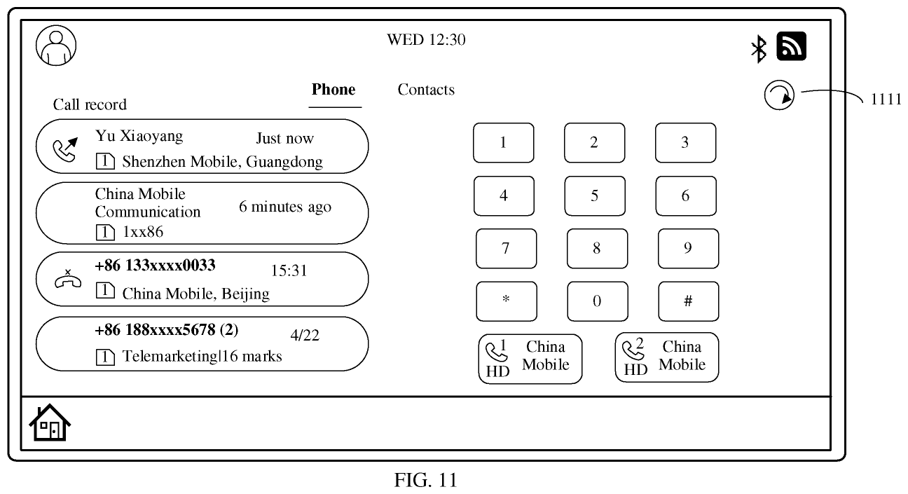

Specifically, it is assumed that the electronic device 100 is a mobile phone, and the electronic device 200 is a head unit. After synchronizing data of the electronic device 100, the electronic device 200 may record, in the persistent medium (for example, preferences) of the electronic device 200, time at which synchronization is completed. The electronic device 200 may display a “refresh” option (for example, an option 1111 shown in FIG. 11). When the user taps the option, the electronic device 200 may send a synchronization request to the electronic device 100 by using the distributed data service (or another communication mechanism). The synchronization request may include an event that triggers data refresh (for example, an event that triggers data that needs to be updated) and time at which previous data synchronization is completed. The electronic device 100 may search, based on the event that triggers data refresh and the time at which previous data synchronization is completed, for a record in which latest refresh time of corresponding data is later than the time at which previous data synchronization is completed, and write the record into the distributed database. Further, the record may be synchronized to the electronic device 200, to complete data refresh. After refresh is completed, the electronic device 200 may further record time at which current synchronization is completed for use in next data refresh.

The following describes internal modules of an electronic device 100 and an electronic device 200 in a data synchronization process and a possible collaboration manner between the internal modules according to an embodiment of this application.

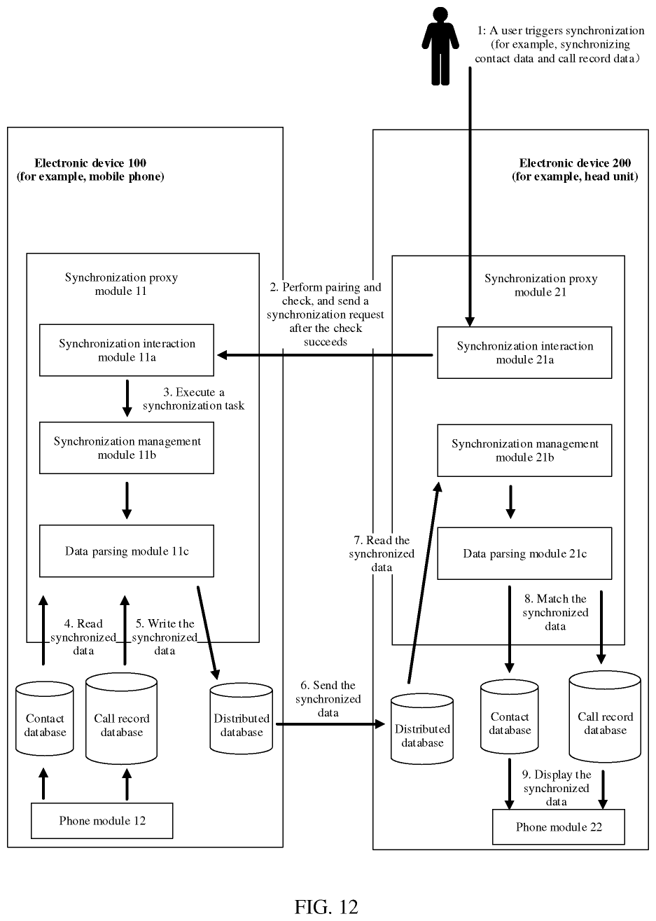

FIG. 12 shows an example of internal modules of an electronic device 100 and an electronic device 200 in a data synchronization process and a possible collaboration manner between the internal modules according to an embodiment of this application.

As shown in FIG. 12, the electronic device 100 may include a synchronization proxy module 11 (which may also be referred to as a synchronization proxy application 11), a contact database, a call record database, a distributed database, and a phone module 12 (which may also be referred to as a phone application 12). The synchronization proxy module 11 may include a synchronization interaction module 11a, a synchronization management module 11b, and a data parsing module 11c. The electronic device 200 may include a synchronization proxy module 21 (which may also be referred to as a synchronization proxy application 21), a contact database, a call record database, a distributed database, and a phone module 22 (which may also be referred to as a phone application 22). The synchronization proxy module 21 may include a synchronization interaction module 21a, a synchronization management module 21b, and a data parsing module 21c.

The synchronization interaction module (for example, the synchronization interaction module 11a and the synchronization interaction module 21a) may be configured to perform pairing, perform check, exchange necessary information, be responsible for mutual confirmation of functions and version information between two devices, trigger synchronization when a matching condition is met, and the like.

For example, the synchronization interaction module 21a may detect an operation of triggering synchronization (for example, synchronizing the contact data or the call record data) by the user, and then the synchronization interaction module 21a may perform pairing and check. If it is determined that the device that currently establishes the Bluetooth connection to the electronic device 200 is the electronic device 100, it indicates that the check succeeds. In addition, when the distributed database technology needs to be used to synchronize additional information, the synchronization interaction module 21a further needs to determine whether the electronic device that establishes the Bluetooth connection to the electronic device 200 and the electronic device that logs in to the same account as the electronic device 200 are a same electronic device. If yes, for example, the same electronic device is the electronic device 100, it indicates that the check succeeds. After the check succeeds, the synchronization interaction module 21a may initiate a synchronization service of the electronic device 100. For example, the synchronization interaction module 21a may send a synchronization request to the synchronization interaction module 11a. Further, the synchronization interaction module 11a may indicate the synchronization management module 11b to execute a synchronization task.

The synchronization management module (for example, the synchronization management module 11b and the synchronization management module 21b) may be configured to: receive an instruction for executing a synchronization task from the synchronization interaction module, execute the synchronization task, manage the entire synchronization process, indicate the data parsing module to read data that needs to be synchronized, perform status management (for example, monitor a data change in the database), and the like.

For example, after receiving the instruction for executing a synchronization task from the synchronization interaction module 11a, the synchronization management module 11b may indicate the data parsing module 11c to read the data (for example, the contact data and the call record data) that needs to be synchronized. After reading the data that needs to be synchronized, the data parsing module 11c may further write the synchronized data into the distributed database of the electronic device 100. After detecting that the data in the distributed database of the electronic device 100 changes, the synchronization management module 11b may indicate the distributed database of the electronic device 100 to send the synchronized data to the distributed database of the electronic device 200 by using the distributed data service.

For example, after detecting that the data in the distributed database of the electronic device 200 changes, the synchronization management module 21b may read the synchronized data, and send the synchronized data to the data parsing module 21c.

The data parsing module (for example, the data parsing module 11c and the data parsing module 21c) may be configured to be responsible for reading, parsing, checking, converting, and inserting the contact data, the call record data, and the like.

For example, after receiving an instruction for reading data that needs to be synchronized from the synchronization management module 11b, the data parsing module 11c may read the contact data from the contact database of the electronic device 100, and read the call record data from the call record database of the electronic device 100. Further, format conversion (for example, conversion into data in a key-value form) may be performed on the read data, and the data is written into the distributed database of the electronic device 100.

For example, the data parsing module 21c may receive the synchronized data sent by the synchronization management module 21b, and parse the data. When the synchronized data is data synchronized from the distributed database, the data parsing module 21c may match the synchronization data with the data synchronized by using Bluetooth, and write the data into corresponding locations in the contact database and the call record database.

When Bluetooth is used to synchronize data in the PBAP profile, after reading the synchronized data, the data parsing module 11c may send the synchronized data to the synchronization management module 11b. The synchronization management module 11b may send the synchronized data to the synchronization management module 21b, and the synchronization management module 21b may send the synchronized data to the data parsing module 21c. The data parsing module 21c may parse the synchronized data, and write the synchronized data into the contact database and the call record database.

When the socket communication manner is used to synchronize data, after reading the synchronized data, the data parsing module 11c may send the synchronized data to the synchronization management module 11b. The synchronization management module 11b may send the synchronized data to the synchronization management module 21b, and the synchronization management module 21b may send the synchronized data to the data parsing module 21c. The data parsing module 21c may parse the synchronized data, match the synchronized data with the data synchronized by using Bluetooth, and write the synchronized data into corresponding locations in the contact database and the call record database. In this case, the electronic device 100 and the electronic device 200 may not include a distributed database.

The contact database (for example, the contact database of the electronic device 100 and the contact database of the electronic device 200) may be configured to store the contact data (for example, a name, a phone number, and a profile picture of a contact).

The call record database (for example, the call record database of the electronic device 100 and the call record database of the electronic device 200) may be configured to store the call record data (for example, a phone number, SIM card information, a home location of an operator, yellow page information, and a call status).

The distributed database (for example, the distributed database of the electronic device 100 and the distributed database of the electronic device 200) may be configured to store the contact data, the call record data, and the like. The distributed database is a non-relational database, and data in the distributed database is organized, indexed, and stored in a key-value form.

The phone module (for example, the phone module 12 and the phone module 22) may be configured to make a call, read the contact data, the call record data, and the like, write the contact data into the contact database, write the call record data into the call record database, display synchronized data, and the like.

In embodiments of this application, both the contact database and the call record database may be existing universal databases, and data stored in the two databases may be synchronized with data in another electronic device. This is not limited thereto. The data stored in the two databases may also be used by another application (for example, a voice assistant or a third-party application) on the local device other than the phone application when usage permission is granted to the another application.

For more details about functions of the internal modules of the electronic device 100 and the electronic device 200, refer to related content in the foregoing embodiments. Details are not described herein again.

It may be understood that the structure shown in FIG. 12 does not constitute a specific limitation on the electronic device 100 and the electronic device 200. In some other embodiments of this application, the electronic device 100 and the electronic device 200 may have more or fewer components than those shown in FIG. 12, may combine two or more components, or may have different component configurations. Various components shown in the figure may be implemented in hardware, software, or a combination of hardware and software. The hardware, software, or the combination of hardware and software include one or more signal processing and/or application-specific integrated circuits.

The following describes internal modules of the electronic device 100 and the electronic device 200 in a data synchronization process by using a distributed data service and a possible collaboration manner between the internal modules according to an embodiment of this application.

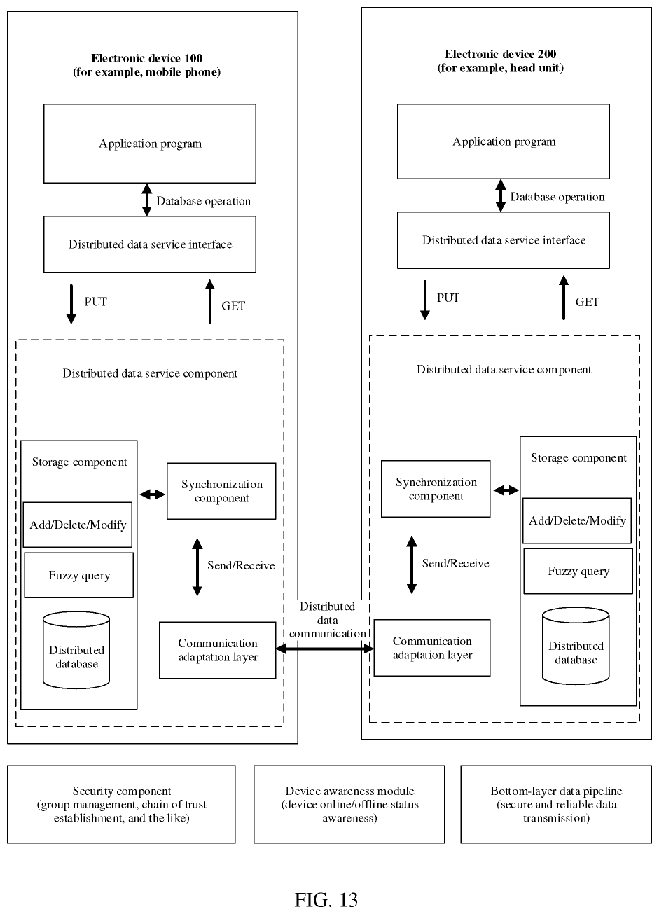

FIG. 13 shows an example of internal modules of an electronic device 100 and an electronic device 200 in a data synchronization process by using a distributed data service and a possible collaboration manner between the internal modules according to an embodiment of this application.

As shown in FIG. 13, the electronic device 100 may include an application program, a distributed data service interface, a distributed data service component, a storage component, a synchronization component, a communication adaptation layer, a security component, a device awareness module, and an underlying data pipeline. The electronic device 200 may also include an application program, a distributed data service interface, a distributed data service component, a storage component, a synchronization component, a communication adaptation layer, a security component, a device awareness module, and an underlying data pipeline.

The application program may be configured to trigger execution of a data synchronization task, read (GET) data from a database, write (PUT) data into a database, and the like. In embodiments of this application, the application program may include but is not limited to a synchronization proxy application program and a phone application program.

The distributed data service interface may provide interfaces for database creation, data access, and data subscription for another internal component (for example, the application program). The interface supports a key-value data model and a common data model. In addition, the distributed data service ensures the interface to be compatible, easy to use, and publishable.

The distributed data service component may be used for metadata management, permission management, backup and restoration management, and multi-user management in a service, and may further be configured to initialize the storage component, the synchronization component, and the communication adaptation layer of an underlying distributed database.

The storage component may be configured to be responsible for features such as data access, data reduction, a transaction, a snapshot, data combination, and conflict resolution.

The synchronization component may be configured to maintain data consistency between databases in online electronic devices, including synchronizing locally generated unsynchronized data to another electronic device, receiving data from another electronic device, and combining the data into the local device.

The communication adaptation layer may be configured to invoke an interface at a bottom-layer public communication layer to complete creation and connection of a communication channel, receive an online/offline message of an electronic device, and maintain metadata of a list of connected devices and a list of devices connected to ports. In addition, the communication adaptation layer may further send the online/offline message of the electronic device to the synchronization component, and the synchronization component may maintain the list of connected devices. During data synchronization, an interface at the communication adaptation layer may be invoked based on the list to encapsulate data and send the encapsulated data to the connected electronic device.

After completing device discovery and authentication, the bottom-layer communication component may notify the communication adaptation layer that electronic devices are online. After receiving a message indicating that the electronic devices are online, the communication adaptation layer may establish an encrypted data transmission channel between the two electronic devices, and perform data synchronization between the two electronic devices through the channel. The data synchronization process may be performed through a Wi-Fi channel (or another channel). This is not limited in embodiments of this application.

The application program may invoke the distributed data service interface to create, access, and subscribe to the distributed database. The distributed data service interface stores data to the storage component by operating a capability provided by the distributed data service component. The storage component may invoke the synchronization component to synchronize data. The synchronization component uses the communication adaptation layer to synchronize data to a remote device. The remote device may receive the data by using the synchronization component, and update the data to a local storage component. In this way, data synchronization between two electronic devices is complete.

The distributed data service provides two synchronization modules: a manual synchronization mode and an automatic synchronization mode.

In the manual synchronization mode, the user needs to manually trigger data synchronization. For example, when starting a phone application program on the electronic device 200, the user may trigger the electronic device 200 to synchronize contact data and call record data on another electronic device (for example, the electronic device 100).

In the automatic synchronization mode, the user does not need to manually trigger data synchronization, and data synchronization may be completed by using the distributed database. Synchronization time may include but is not limited to going online of an electronic device, modifying data, and the like.

It may be understood that the structure shown in FIG. 13 does not constitute a specific limitation on the electronic device 100 and the electronic device 200. In some other embodiments of this application, the electronic device 100 and the electronic device 200 may have more or fewer components than those shown in FIG. 13, may combine two or more components, or may have different component configurations. Various components shown in the figure may be implemented in hardware, software, or a combination of hardware and software. The hardware, software, or the combination of hardware and software include one or more signal processing and/or application-specific integrated circuits.

The following describes another data transmission method provided in embodiments of this application.

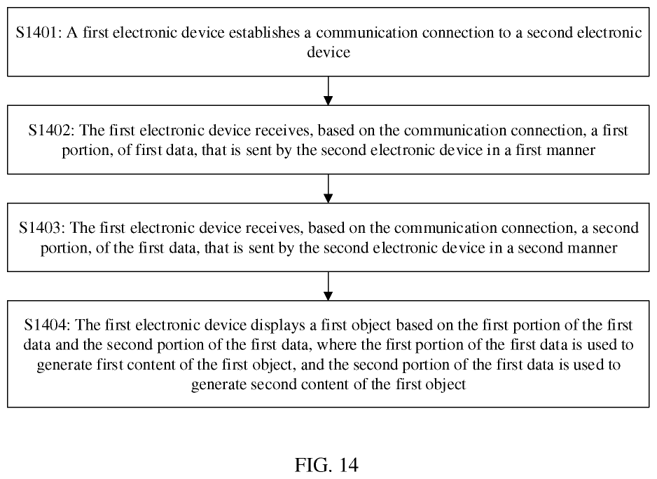

FIG. 14 shows an example of a specific procedure of another data transmission method according to an embodiment of this application.

As shown in FIG. 14, the method may be used in a communication system including a first electronic device (namely, the electronic device 200) and a second electronic device (namely, the electronic device 100). In an embodiment of this application, the electronic device 100 may be a mobile phone, and the electronic device 200 may be a head unit. The following describes in detail specific steps of the method.

S1401: The first electronic device establishes a communication connection to the second electronic device.

The first electronic device may be the electronic device 200 (for example, a head unit), and the second electronic device may be the electronic device 100 (for example, a mobile phone). The communication connection established between the first electronic device and the second electronic device may include but is not limited to a Bluetooth connection, a Wi-Fi connection, an NFC connection, an IR connection, a 3G/4G/5G mobile communication network, and the like. Alternatively, the first electronic device and the second electronic device may establish the communication connection by combining any several manners described above. This is not limited in embodiments of this application.

For example, as shown in FIG. 5, the first electronic device may establish the Bluetooth communication connection to the second electronic device and perform communication, or may log in to the same account (for example, a same Huawei account) to establish the connection and perform communication through a Wi-Fi channel or another channel.

S1402: The first electronic device receives, based on the communication connection, a first portion, of first data, that is sent by the second electronic device in a first manner. The communication connection may be a Bluetooth communication connection. The first manner may be a PBAP profile manner. The first data may be phone book data. The phone book data may include address book data (or referred to as contact data) and call record data. The first portion of the first data may be data that can be sent according to the PBAP profile, for example, the contact data 1 and the call record data 1 shown in FIG. 5.

S1403: The first electronic device receives, based on the communication connection, a second portion, of the first data, that is sent by the second electronic device in a second manner. The communication connection may be a Wi-Fi communication connection or another communication connection (for example, a 3G/4G/5G mobile communication network). The second manner may be a manner of a service related to data synchronization. The first data may be phone book data. The phone book data may include address book data (or referred to as contact data) and call record data. The second portion of the first data may be data sent by using the service related to data synchronization, for example, the contact data 2 and the call record data 2 shown in FIG. 5.

The service related to data synchronization may be provided by a device vendor, for example, a distributed data service provided by Huawei. If both the first electronic device and the second electronic device support the service related to data synchronization, the two electronic devices may perform data synchronization according to a private protocol (for example, synchronizing data that cannot be synchronized according to the PBAP).

In some embodiments, the service related to data synchronization may be provided in a form of an interface for use by the first electronic device and the second electronic device.

In embodiments of this application, the service related to data synchronization may be a distributed data service provided by Huawei. For a specific execution process and a principle of performing data synchronization by using the distributed data service, refer to related content in the foregoing embodiments. Details are not described herein again.

It should be noted that when the second portion of the first data is synchronized by using the service related to data synchronization, both the first electronic device and the second electronic device need to support the service related to data synchronization, so that the second portion of the first data can be successfully synchronized. Otherwise, the second portion of the first data cannot be successfully synchronized.

S1404: The first electronic device displays a first object based on the first portion of the first data and the second portion of the first data, where the first portion of the first data is used to generate first content of the first object, and the second portion of the first data is used to generate second content of the first object.

The first object may be an address book or a call record that is on the second electronic device and that is displayed by the first electronic device. The first content of the first object may be generated based on the first portion of the first data, for example, the call record that includes only the name and the phone number of the contact shown in FIG. 7A, or the address book that includes only the name of the contact shown in FIG. 7B. The second content of the first object may be generated based on the second portion of the first data, for example, the call record that includes the identifier of the SIM card, the yellow page information, the home location of the operator, the identifier of the rejected call, and the mark information (for example, telemarketing) shown in FIG. 8A, or the address book that includes the profile picture of the contact shown in FIG. 8B.

It should be noted that only when both the first electronic device and the second electronic device support the service related to data synchronization, the first electronic device can display the first content of the first object and the second content of the first object at the same time. Otherwise, the first electronic device displays only the first content of the first object, and cannot display the second content of the first object.

In an embodiment of this application, the second electronic device may further send information about a SIM card of the second electronic device to the first electronic device by using a service related to data synchronization (for example, the distributed data service provided by Huawei) or a socket. If a plurality of SIM cards are installed in the second electronic device, for example, two SIM cards: a SIM card 1 (which may also be referred to as a first SIM card) and a SIM card 2 (which may also be referred to as a second SIM card), the second electronic device may send information about the SIM card 1 and information about the SIM card 2 to the first electronic device. The first electronic device may generate a first option (for example, the option 815 shown in FIG. 8A or the option 1011 shown in FIG. 10A) and a second option (for example, the option 816 shown in FIG. 8A or the option 1012 shown in FIG. 10A) based on the information about the SIM card 1 and the information about the SIM card 2. For example, when the user selects the SIM card 1 to initiate a call business (for example, an operation of tapping the first option by the user), the first electronic device may send a call request (for example, the call request shown in FIG. 9) to the second electronic device. After receiving the first request, the second electronic device may perform the call business by using the SIM card 1, and may further send a first message (for example, the instruction of synchronously performing a call business shown in FIG. 9) to the first electronic device. After receiving the first message, the first electronic device may display a call screen.

It is easy to understand that when the information about the SIM card is synchronized by using the service related to data synchronization, both the first electronic device and the second electronic device need to support the service related to data synchronization, so that synchronization succeeds.

The following describes a structure of an electronic device 100 according to an embodiment of this application.

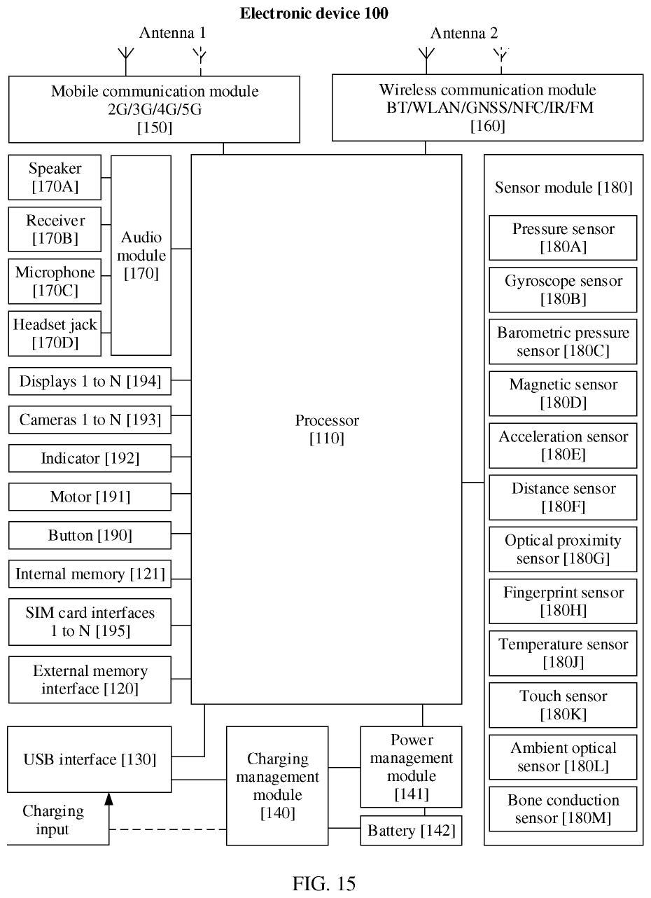

FIG. 15 shows an example of a structure of an electronic device 100 according to an embodiment of this application.

As shown in FIG. 15, the electronic device 100 may include: a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural network processing unit (neural network processing unit, NPU), and/or the like. Different processing units may be independent components, or may be integrated into one or more processors.

In this embodiment of this application, the processor 110 may synchronize related data (for example, synchronizing contact data and call record data) based on a data synchronization request sent by the electronic device 200 (for example, a head unit). For a specific data synchronization process, refer to related content in the foregoing embodiments. Details are not described herein again.

The controller may be a nerve center and a command center of the electronic device 100. The controller may generate an operation control signal based on an instruction operation code and a time sequence signal, to complete control of instruction reading and instruction execution.

A memory may further be disposed in the processor 110, and is configured to store instructions and data. In some embodiments, the memory in the processor 110 is a cache memory. The memory may store an instruction or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

It can be understood that an interface connection relationship between modules illustrated in this embodiment of this application is merely an illustrative description, and does not constitute a limitation on a structure of the electronic device 100. In some other embodiments of this application, the electronic device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some embodiments of wired charging, the charging management module 140 may receive a charging input of a wired charger through the USB interface 130. In some embodiments of wireless charging, the charging management module 140 may receive a wireless charging input through a wireless charging coil of the electronic device 100. When charging the battery 142, the charging management module 140 may further supply power to the electronic device 100 by using the power management module 141.

The power management module 141 is configured to be connected to the battery 142, the charging management module 140, and the processor 110. The power management module 141 receives input of the battery 142 and/or the charging management module 140, to supply power to the processor 110, the internal memory 121, an external memory, the display 194, the camera 193, the wireless communication module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may further be reused, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that is used in the electronic device 100 and that includes 2G/3G/4G/5G or the like. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules of the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by an audio device (which is not limited to the speaker 170A, the receiver 170B, or the like), or displays an image or a video by the display 194. In some embodiments, the modem processor may be an independent component. In some other embodiments, the modem processor may be independent of the processor 110, and is disposed in a same device as the mobile communication module 150 or another functional module.

The wireless communication module 160 may provide a wireless communication solution that is applied to the electronic device 100, and that includes a wireless local area network (wireless local area network, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like. The wireless communication module 160 may be one or more components integrating at least one communication processor module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, the antenna 1 and the mobile communication module 150 in the electronic device 100 are coupled, and the antenna 2 and the wireless communication module 160 in the electronic device 100 are coupled, so that the electronic device 100 can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite-based augmentation system (satellite-based augmentation system, SBAS).

In this embodiment of this application, the electronic device 100 may establish the communication connection (for example, a Bluetooth communication connection or a Wi-Fi communication connection) with the electronic device 200 by using the mobile communication module and the wireless communication module.

The electronic device 100 may implement a display function by using the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, which execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini-LED, a micro-LED, a micro-OLED, a quantum dot light emitting diode (quantum dot light emitting diode, QLED), or the like. In some embodiments, the electronic device 100 may include one or N displays 194, where N is a positive integer greater than 1.

The electronic device 100 may implement a photographing function by using the camera 193, the ISP, the video codec, the GPU, the display 194, the application processor and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness and the like of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The video codec is configured to compress or decompress a digital video. The electronic device 100 may support one or more video codecs. In this way, the electronic device 100 may play or record videos in a plurality of coding formats, for example, moving picture experts group (moving picture experts group, MPEG)-1, MPEG-2, MPEG-3, and MPEG-4.

The NPU is a neural network (neural network, NN) computing processor, and simulates a biological neural network structure like a transmission mode between neurons in a human brain to perform rapid processing on input information, and can perform continuous self-learning. Applications such as intelligent cognition of the electronic device 100 may be implemented by using the NPU, for example, image recognition, facial recognition, speech recognition, and text understanding.

The external memory interface 120 may be used to connect to an external storage card, for example, a micro SD card, to extend a storage capability of the electronic device 100. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The processor 110 runs the instructions stored in the internal memory 121, to perform various functional applications of the electronic device 100 and data processing. The internal memory 121 may include a program storage area and a data storage area. The program storage area may store an operating system, an application program required by at least one function (for example, a voice playing function or an image playing function), and the like. The data storage area may store data (such as audio data and an address book) created during use of the electronic device 100, and the like. In addition, the internal memory 121 may include a high-speed random access memory, or may include a nonvolatile memory, for example, at least one magnetic disk storage device, a flash memory, or a universal flash storage (universal flash storage, UFS).

The electronic device 100 may implement an audio function, for example, music playing and recording, by using the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may further be configured to encode and decode an audio signal. In some embodiments, the audio module 170 may be disposed in the processor 110, or some functional modules in the audio module 170 are disposed in the processor 110.

The speaker 170A, also referred to as a “loudspeaker”, is configured to convert an audio electrical signal into a sound signal. The electronic device 100 may be used to listen to music or answer a call in a hands-free mode over the speaker 170A.

The receiver 170B, also referred to as an “earpiece”, is configured to convert an audio electrical signal into a sound signal. When a call is answered or speech information is received through the electronic device 100, the receiver 170B may be put close to a human ear to listen to a voice.

The microphone 170C, also referred to as a “mike” or a “mic”, is configured to convert a sound signal into an electrical signal. When making a call or sending voice information, a user may make a sound near the microphone 170C through the mouth of the user, to input a sound signal to the microphone 170C. At least one microphone 170C may be disposed in the electronic device 100. In some other embodiments, two microphones 170C may be disposed in the electronic device 100, to collect a sound signal and implement a noise reduction function. In some other embodiments, three, four, or more microphones 170C may alternatively be disposed in the electronic device 100, to collect a sound signal, implement noise reduction, and identify a sound source, so as to implement a directional recording function and the like.

The headset jack 170D is configured to connect to a wired headset. The headset jack 170D may be the USB interface 130, or may be a 3.5 mm open mobile terminal platform (open mobile terminal platform, OMTP) standard interface or a Cellular Telecommunications Industry Association of the USA (Cellular Telecommunications Industry Association of the USA, CTIA) standard interface.

The touch sensor 180K is also referred to as a touch panel. The touch sensor 180K may be disposed on the display 194, and the touch sensor 180K and the display 194 form a touchscreen, which is also referred to as a “touchscreen”. The touch sensor 180K is configured to detect a touch operation performed on or near the touch sensor. The touch sensor may transfer the detected touch operation to the application processor to determine a type of the touch event. A visual output related to the touch operation may be provided through the display 194. In some other embodiments, the touch sensor 180K may also be disposed on a surface of the electronic device 100 at a location different from that of the display 194.

The button 190 includes a power button, a volume button, and the like. The button 190 may be a mechanical button, or may be a touch button. The electronic device 100 may receive a key input, and generate a key signal input related to a user setting and function control of the electronic device 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display 194. Different application scenarios (for example, a time reminder, information receiving, an alarm clock, and a game) may also correspond to different vibration feedback effects. A touch vibration feedback effect may further be customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface 195 is also compatible with an external storage card. The electronic device 100 interacts with a network through the SIM card, to implement functions such as conversation and data communication. In some embodiments, the electronic device 100 uses an eSIM, that is, an embedded SIM card. The eSIM card may be embedded into the electronic device 100, and cannot be separated from the electronic device 100.

In embodiments of this application, a plurality of SIM cards may be installed in the electronic device 100. When the plurality of SIM cards are installed, for example, two SIM cards are installed, the electronic device 100 may synchronize information (for example, identifier information of the SIM card, a phone number corresponding to the SIM card, and a home location of an operator) about the two SIM cards to the electronic device 200 that establishes the communication connection to the electronic device 100. In this way, the user may select a corresponding SIM card on the electronic device 200 to perform a call business. For a specific process of synchronizing the information about the SIM card, refer to related content in the foregoing embodiments. Details are not described herein again.

It should be understood that the electronic device 100 shown in FIG. 15 is merely an example, and the electronic device 100 may have more or fewer components than those shown in FIG. 15, may combine two or more components, or may have different component configurations. Various components shown in FIG. 15 may be implemented in hardware, software, or a combination of hardware and software. The hardware, software, or the combination of hardware and software include one or more signal processing and/or application-specific integrated circuits.

All or some of the embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on the computer, the procedure or functions according to this application are all or partially generated. The computer may be a general-purpose computer, a special-purpose computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (solid-state disk, SSD)), or the like.

A person of ordinary skill in the art may understand that all or some of the procedures of the methods in the foregoing embodiments may be implemented by a computer program indicating related hardware. The program may be stored in a computer-readable storage medium. When the program is executed, the procedures of the methods in the foregoing embodiments may be performed. The foregoing storage medium includes any medium that can store program code, for example, a ROM, a random access memory RAM, a magnetic disk, or an optical disc.

The foregoing embodiments are merely intended for describing the technical solutions of this application, rather than limiting this application. Although this application is described in detail with reference to the foregoing embodiments, a person of ordinary skill in the art should understand that modifications may still be made to the technical solutions described in the foregoing embodiments or equivalent replacements are made to some technical features thereof, without departing from the scope of the technical solutions of embodiments of this application.

1-30. (canceled)

31. A method, comprising:
establishing, by a first electronic device, a communication connection to a second electronic device;
receiving, by the first electronic device, based on the communication connection, a first portion of first data, the first portion of the first data being sent by the second electronic device in a first manner;
receiving, by the first electronic device based on the communication connection, a second portion of the first data, the second portion of the first data being sent by the second electronic device in a second manner; and
displaying, by the first electronic device, a first object based on the first portion of the first data and the second portion of the first data, wherein the first manner is different from the second manner, first content of the first object is generated based on the first portion of the first data, and second content of the first object is generated based on the second portion of the first data.

32. The method according to claim 31, wherein the first data is phone book data, and the phone book data comprises address book data or call record data.

33. The method according to claim 31, wherein receiving, by the first electronic device based on the communication connection, the first portion of the first data comprises:
receiving, by the first electronic device based on the communication connection, the first portion of the first data, the first portion of the first data being sent by the second electronic device according to a phone book access profile (PBAP).

34. The method according to claim 31, wherein receiving, by the first electronic device based on the communication connection, the second portion the first data comprises:
receiving, by the first electronic device based on the communication connection, the second portion of the first data that is sent by the second electronic device through a service related to data synchronization, wherein the first electronic device is associated with the second electronic device by logging in to a first account; or
receiving, by the first electronic device based on the communication connection, the second portion of the first data that is sent by the second electronic device through a socket.

35. The method according to claim 34, wherein the service related to data synchronization comprises a distributed data service.

36. The method according to claim 31, wherein the first portion of the first data comprises first phone number data, the second portion of the first data comprises: identifier data of a SIM card, home data of an operator, yellow page data, or identifier data of a call status, the first object comprises a first call record, the first call record is a call record corresponding to a first phone number, the first content comprises the first phone number, and the second content comprises: an identifier of a SIM card that generates the first call record, a home location of an operator of the first phone number, a yellow page name of the first phone number, or an identifier of a call status of the first phone number.

37. The method according to claim 36, wherein the first call record is a call record of a rejected incoming call, and the second content comprises an identifier indicating that the call status of the first phone number is a rejected state.

38. The method according to claim 36, wherein the second portion of the first data further comprises first mark data, and when the first phone number is a phone number of a telemarketing type, the first mark data comprises a telemarketing mark, and the second content comprises the telemarketing mark.

39. The method according to claim 31, wherein the first portion of the first data comprises name data of a first contact and phone number data of the first contact, the second portion of the first data comprises profile picture data of the first contact, the first object comprises a first address book entry, the first address book entry is an address book entry corresponding to the first contact, the first content comprises a name of the first contact, and the second content comprises a profile picture of the first contact.

40. The method according to claim 31, wherein before displaying, by the first electronic device, the first object based on the first portion of the first data and the second portion of the first data, the method further comprises:
determining, by the first electronic device based on a first identifier and a second identifier, that the first portion of the first data is associated with the second portion of the first data, wherein
the first identifier is an identifier of the first portion of the first data, and the second identifier is an identifier of the second portion of the first data.

41. The method according to claim 31, wherein after displaying, by the first electronic device, the first object based on the first portion of the first data and the second portion of the first data, the method further comprises:
receiving, by the first electronic device under a first condition, second data sent by the second electronic device, and displaying the first object based on the second data,
wherein the first condition comprises:
the second electronic device detects that the first data changes to the second data; or
the first electronic device detects a refresh operation of a user, and sends a first request to the second electronic device, wherein the first request indicates the second electronic device to send the second data to the first electronic device.

42. The method according to claim 31, wherein after displaying, by the first electronic device, the first object based on the first portion of the first data and the second portion of the first data, the method further comprises:
when the communication connection is disconnected, clearing, by the first electronic device, the first portion of the first data and the second portion of the first data.

43. The method according to claim 31, wherein before receiving, by the first electronic device based on the communication connection, the first portion of first data, the method further comprises:
detecting, by the first electronic device, an operation of viewing the first object by a user.

44. A method, comprising:
establishing, by a second electronic device, a communication connection to a first electronic device;
sending, by the second electronic device, a first portion of first data to the first electronic device in a first manner based on the communication connection; and
sending, by the second electronic device, a second portion of the first data to the first electronic device in a second manner based on the communication connection, wherein the first manner is different from the second manner, the second electronic device displays a first object based on the first portion of the first data and the second portion of the first data, the first electronic device generates first content of the first object based on the first portion of the first data, and the first electronic device generates second content of the first object based on the second portion of the first data.

45. The method according to claim 44, wherein the first data is phone book data, and the phone book data comprises address book data or call record data.

46. The method according to claim 44, wherein sending, by the second electronic device, the first portion of first data to the first electronic device in the first manner based on the communication connection comprises:
sending, by the second electronic device, the first portion of the first data to the first electronic device based on the communication connection and a phone book access profile (PBAP).

47. The method according to claim 44, wherein sending, by the second electronic device, the second portion of the first data to the first electronic device in the second manner based on the communication connection comprises:
sending, by the second electronic device, the second portion of the first data to the first electronic device based on the communication connection and through a service related to data synchronization, wherein the first electronic device is associated with the second electronic device by logging in to a first account; or
sending, by the second electronic device, the second portion of the first data to the first electronic device based on the communication connection and through a socket.

48. The method according to claim 47, wherein the service related to data synchronization comprises a distributed data service.

49. The method according to claim 44, wherein the first portion of the first data comprises first phone number data, the second portion of the first data comprises: identifier data of a SIM card, home data of an operator, yellow page data, or identifier data of a call status, the first object comprises a first call record, the first call record is a call record corresponding to a first phone number, the first content comprises the first phone number, and the second content comprises: an identifier of a SIM card that generates the first call record, a home location of an operator of the first phone number, a yellow page name of the first phone number, or an identifier of a call status of the first phone number.

50. The method according to claim 44, wherein the first portion of the first data comprises name data of a first contact and phone number data of the first contact, the second portion of the first data comprises profile picture data of the first contact, the first object comprises a first address book entry, the first address book entry is an address book entry corresponding to the first contact, the first content comprises a name of the first contact, and the second content comprises a profile picture of the first contact.

51. An electronic device, comprising:
at least one processor; and
a memory coupled to the at least one processor with instructions stored thereon, wherein the instructions, when executed by the at least one processor, cause the electronic device to perform operations comprising:
establishing a communication connection to a second electronic device;
receiving, based on the communication connection, a first portion of first data, the first portion of the first data being sent by the second electronic device in a first manner;
receiving, based on the communication connection, a second portion of the first data, the second portion of the first data being sent by the second electronic device in a second manner; and
displaying a first object based on the first portion of the first data and the second portion of the first data, wherein
the first manner is different from the second manner, first content of the first object is generated based on the first portion of the first data, and second content of the first object is generated based on the second portion of the first data.
